(19) United States
(12) Patent Application Publication
(10) Pub. No.: US 2026/0106779 A1
(43) Pub. Date: Apr. 16, 2026

(54) DURATION DETERMINATION METHOD AND APPARATUS, AND STORAGE MEDIUM

(71) Applicant: Beijing Xiaomi Mobile Software Co., Ltd., Beijing (CN)

(72) Inventor: Min LIU, Beijing (CN)

(21) Appl. No.: 19/116,766

(22) PCT Filed: Sep. 30, 2022
(86) PCT No.: PCT/CN2022/123550

§ 371 Date: Mar. 28, 2025

(51) Int. Cl. H04L 25/02

(52) U.S. Cl. CPC H04L 25/0224

(57) ABSTRACT

A method for determining a duration is performed by a terminal, and includes: determining a first duration, wherein the first duration is a maximum span supported by the terminal for performing joint channel estimation on uplink channel; reporting the first duration to a base station; determining a second duration for performing joint channel estimation on uplink channel, wherein the second duration is less than or equal to the first duration; and determining that the second duration takes effect.

### CROSS-REFERENCE TO RELATED APPLICATION

The present application is a U.S. National Stage of International Application No. PCT/CN2022/123550, filed on Sep. 30, 2022, the contents of which are incorporated herein by reference in their entirety.

### TECHNICAL FIELD

The present disclosure relates to the field of communications and, in particular, to duration determination methods and apparatuses, and storage media.

### BACKGROUND

In Release-17 (Rel-17) of the 3rd Generation Partnership Project (3GPP), the coverage of uplink channels in terrestrial networks can be enhanced by the Demodulation Reference Signal (DMRS) bundling technology. In order to ensure that a base station can demodulate an uplink channel signal across time units, the terminal needs to ensure power consistency and phase continuity within a certain time window. Since a location of the base station remains unchanged, a terminal reports a maximum span of joint channel estimation supported by the terminal once, and the base station can determine that the terminal can maintain power consistency and phase consistency within the maximum span.

However, in a Non-terrestrial Network (NTN), due to the high mobility of satellites, the terminal cannot guarantee power consistency and phase consistency throughout the entire maximum span. This results in lower reliability when enhancing uplink coverage through joint channel estimation.

### SUMMARY

In order to overcome the problems existing in the related art, embodiments of the present disclosure provide following a method and apparatus for determining a duration, and a storage medium, which can dynamically determine the duration of joint channel estimation by a terminal and a base station in an NTN network, realize the purpose of enhancing the coverage of the uplink channel in the NTN network, and improve the reliability of the uplink transmission in the NTN network.

According to a first aspect of an embodiment of the present disclosure, a method for determining a duration is provided, which is performed by a terminal and includes:
determining a first duration, where the first duration is a maximum span supported by the terminal for performing joint channel estimation on uplink channel;
reporting the first duration to a base station;
determining a second duration for performing joint channel estimation on uplink channel, where the second duration is less than or equal to the first duration; and
determining that the second duration takes effect.

In some examples, the method further includes:
receiving at least one binding duration of a demodulation reference signal (DMRS), where the at least one binding duration is sent by the base station and less than or equal to the first duration;
the determining a second duration for performing joint channel estimation on uplink channel includes any one of:
when the at least one binding duration includes one binding duration, determining the second duration to be less than or equal to the one binding duration; and
when the at least one binding duration includes a plurality of binding durations, determining one of the plurality of binding durations as the second duration.

In some examples, the determining a second duration for performing joint channel estimation on uplink channel includes:
determining the second duration based on the first duration.

In some examples, the method further includes:
reporting the second duration to the base station.

In some examples, the reporting the second duration to the base station includes:
reporting the second duration to the base station through first uplink control information (UCI); or
reporting the second duration to the base station through a first media access control unit (MAC CE).

In some examples, a value indicated by a bit value of a first information field in the first UCI is equal to the second duration; or
the value indicated by the bit value of the first information field in the first UCI is equal to an index value of the second duration.

In some examples, the determining that the second duration takes effect includes at least one of:
determining an effective starting moment of the second duration; or
determining an effective range of the second duration.

In some examples, the determining an effective starting moment of the second duration includes:
determining a first moment for reporting effective indication information, where the effective indication information indicates that the second duration takes effects;
determining an effective interval duration;
determining a second moment after the first moment and spaced apart from the first moment by the effective interval duration; and
taking the second moment as the effective starting moment of the second duration.

In some examples, the determining an effective starting moment of the second duration includes:
determining a third moment carried in the effective indication information as the effective starting moment of the second duration, where the effective indication information indicates that the second duration takes effect.

In some examples, the determining an effective range of the second duration includes any one of:
determining a period from the effective starting moment of the second duration to an effective starting moment of a new second duration as the effective range of the second duration;
determining a period from the effective starting moment of the second duration till completing a first number of uplink transmissions as the effective range of the second duration;
determining a period from the effective starting moment of the second duration to an ineffective starting moment of the second duration as the effective range of the second duration; and
determining a period lasting for a third duration from the effective starting moment of the second duration as the effective range of the second duration.

In some examples, the method further includes:
determine the number of time units occupied by the third duration based on a protocol agreement.

In some examples, the method further includes:
determine the number of time units occupied by the third duration;
sending a notification message to the base station, where the notification message is configured to inform the base station of the number of time units occupied by the third duration.

In some examples, the method further includes:
reporting effective indication information to the base station, where the effective indication information indicates that the second duration takes effect.

In some examples, the reporting the effective indication information to the base station includes:
reporting the effective indication information to the base station through second uplink control information (UCI); or
reporting the effective indication information to the base station through a second media access control unit (MAC CE).

In some examples, the effective indication information further indicates that the terminal supports maintaining power consistency and/or phase continuity within the second duration.

In some examples, the method further includes:
reporting ineffective indication information to the base station, where the ineffective indication information is used for indicating that the second duration becomes ineffective.

In some examples, the reporting the ineffective indication information to the base station includes:
reporting the ineffective indication information to the base station through third uplink control information (UCI); or
reporting the ineffective indication information to the base station through a third media access control unit (MAC CE).

In some examples, a bit value of a first information field in the third UCI indicates an ineffectiveness value.

In some examples, the ineffective indication information further indicates that the terminal is unable to support continuing to maintain power consistency or phase continuity or both within the second duration.

In some examples, the determining that the second duration takes effect includes any one of:
determining that a joint channel estimation for an uplink channel takes effect within the second duration;
determining that a joint channel estimation for a first type of uplink channel takes effect within the second duration; and
determining that a joint channel estimation for a first transmission mode of the first type of uplink channel takes effect within the second duration.

According to a second aspect of an embodiment of the present disclosure, a method for determining a duration is provided, which is performed by a base station and includes:
receiving a first duration reported by a terminal, where the first duration is a maximum span supported by the terminal for performing joint channel estimation on uplink channel;
determining a second duration for performing joint channel estimation on uplink channel, where the second duration is less than or equal to the first duration; and
determining that the second duration takes effect.

In some examples, the method further includes:
determining, based on the first duration, at least one binding duration of a demodulation reference signal (DMRS), where the at least one binding duration is less than or equal to the first duration;
sending the at least one binding duration to the terminal;
the determining a second duration for performing joint channel estimation on uplink channel includes any one of:
when the at least one binding duration includes one binding duration, and the second duration reported by the terminal is not received, taking the one binding duration as the second duration;
when the at least one binding duration includes one binding duration, receiving the second duration reported by the terminal, where the second duration is less than or equal to the one binding duration; and
when the at least one binding duration includes a plurality of binding durations, receiving the second duration reported by the terminal, where the second duration is one of the plurality of binding durations.

In some examples, the determining a second duration for performing joint channel estimation on uplink channel includes:
receiving the second duration reported by the terminal, where the second duration is determined by the terminal based on the first duration.

In some examples, the receiving the second duration reported by the terminal includes:
receiving the second duration reported by the terminal through first uplink control information (UCI); or
receiving the second duration reported by the terminal through a first media access control unit (MAC CE).

In some examples, a value indicated by a bit value of a first information field in the first UCI is equal to the second duration; or
the value indicated by the bit value of the first information field in the first UCI is equal to an index value of the second duration.

In some examples, the determining that the second duration takes effect includes any one of:
determining an effective starting moment of the second duration; and
determining an effective range of the second duration.

In some examples, the determining an effective starting moment of the second duration includes:
determining a first moment when the terminal reports effective indication information, where the effective indication information indicates that the second duration takes effects;
determining an effective interval duration;
determining a second moment after the first moment and spaced apart from the first moment by the effective interval duration; and
taking the second moment as the effective starting moment of the second duration.

In some examples, the determining an effective starting moment of the second duration includes:
determining a third moment carried in the effective indication information reported by the terminal as the effective starting moment of the second duration, where the effective indication information indicates that the second duration takes effect.

In some examples, the determining an effective range of the second duration includes any one of:
determining a period from the effective starting moment of the second duration to an effective starting moment of a new second duration as the effective range of the second duration;
determining a period from the effective starting moment of the second duration till completing a first number of uplink transmissions as the effective range of the second duration;
determining a period from the effective starting moment of the second duration to an ineffective starting moment of the second duration as the effective range of the second duration;
and
determining a period lasting for a third duration from the effective starting moment of the second duration as the effective range of the second duration.

In some examples, the method further includes:
determine the number of time units occupied by the third duration based on a protocol agreement.

In some examples, the method further includes:
receiving a notification message reported by the terminal, where the notification message is configured to inform the base station of the number of time units occupied by the third duration.

In some examples, the method further includes:
receiving effective indication information reported by the terminal, where the effective indication information indicates that the second duration takes effect.

In some examples, the receiving the effective indication information reported by the terminal includes:
receiving the effective indication information reported by the terminal through second uplink control information (UCI); or
receiving the effective indication information reported by the terminal through a second media access control unit (MAC CE).

In some examples, the effective indication information further indicates that the terminal supports maintaining power consistency and/or phase continuity within the second duration.

In some examples, the method further includes:
receiving ineffective indication information reported by the terminal, where the ineffective indication information is used for indicating that the second duration becomes ineffective.

In some examples, the receiving ineffective indication information reported by the terminal includes:
receiving the ineffective indication information reported by the terminal through third uplink control information (UCI); or
receiving the ineffective indication information reported by the terminal through a third media access control unit (MAC CE).

In some examples, a bit value of a first information field in the third UCI indicates an ineffectiveness value.

In some examples, the ineffective indication information further indicates that the terminal is unable to support continuing to maintain power consistency or phase continuity or both within the second duration.

In some examples, the determining that the second duration takes effect includes any one of:
determining that a joint channel estimation for an uplink channel takes effect within the second duration;
determining that a joint channel estimation for a first type of uplink channel takes effect within the second duration; and
determining that a joint channel estimation for a first transmission mode of the first type of uplink channel takes effect within the second duration.

According to a third aspect of an embodiment of the present disclosure, a terminal is provided, including:
a processing module, configured to determine a first duration, where the first duration is a maximum span supported by the terminal for performing joint channel estimation on uplink channel;
a sending module, configured to report the first duration to a base station;
the processing module is further configured to determine a second duration for performing joint channel estimation on uplink channel, where the second duration is less than or equal to the first duration; and
the processing module is further configured to determine that the second duration takes effect.

According to a fourth aspect of an embodiment of the present disclosure, a base station is provided, including:
a receiving module, configured to receive a first duration reported by a terminal, where the first duration is a maximum span supported by the terminal for performing joint channel estimation on uplink channel;
a processing module, configured to determine a second duration for performing joint channel estimation on uplink channel, where the second duration is less than or equal to the first duration; and
the processing module is further configured to determine that the second duration takes effect.

According to a fifth aspect of an embodiment of the present disclosure, a computer-readable storage medium is provided, where the storage medium stores a computer program for executing any one of the methods for determining a duration described above in the terminal side.

According to a sixth aspect of an embodiment of the present disclosure, a computer-readable storage medium is provided, where the storage medium stores a computer program for executing any one of the methods for determining a duration described above in the base station side.

According to a seventh aspect of an embodiment of the present disclosure, a communication apparatus is provided, including:
a processor; and
a memory, configured to store processor-executable instructions;
where the processor is configured to execute any one of the methods for determining a duration described above in the terminal side.

According to an eighth aspect of an embodiment of the present disclosure, a communication apparatus is provided, including:
a processor; and
a memory, configured to store processor-executable instructions;
where the processor is configured to execute any one of the methods for determining a duration described above in the base station side.

According to a ninth aspect of an embodiment of the present disclosure, a communication system is provided, including:
a terminal, configured to execute any one of the methods for determining a duration described above in the terminal side; and
a base station, configured to execute any one of the methods for determining a duration described above in the base station side.

The technical solutions provided by the embodiments of the present disclosure can include the following beneficial effects:
In the embodiments of the present disclosure, the terminal may report a maximum span supported by the terminal for performing joint channel estimation on uplink channel, i.e., the first duration, to the base station, and then determine a second duration for performing joint channel estimation on uplink channel, where the second duration may be less than or equal to the first duration. The terminal may dynamically determine that the second duration takes effect. In the present disclosure, the duration of joint channel estimation can be dynamically determined in the NTN network, thus achieving the purpose of enhancing the coverage of the uplink channel in the NTN network, and improving the reliability of the uplink transmission in the NTN network.

It should be understood that the above general description and the following detailed descriptions are exemplary and explanatory only and do not limit the present disclosure.

### BRIEF DESCRIPTION OF DRAWINGS

The accompanying drawings, which are incorporated in and constitute a part of the specification, illustrate embodiments consistent with the present disclosure, and are used together with the specification to explain the principles of the present disclosure.

FIG. 1 is a schematic flowchart of a method for determining a duration according to an embodiment of the present disclosure.

FIG. 2 is a schematic flowchart of another method for determining a duration according to an embodiment of the present disclosure.

FIG. 3 is a schematic flowchart of another method for determining a duration according to an embodiment of the present disclosure.

FIG. 4 is a schematic flowchart of another method for determining a duration according to an embodiment of the present disclosure.

FIG. 5 is a schematic flowchart of another method for determining a duration according to an embodiment of the present disclosure.

FIG. 6 is a schematic flowchart of another method for determining a duration according to an embodiment of the present disclosure.

FIG. 7 is a schematic flowchart of another method for determining a duration according to an embodiment of the present disclosure.

FIG. 8 is a schematic flowchart of another method for determining a duration according to an embodiment of the present disclosure.

FIG. 9 is a schematic flowchart of another method for determining a duration according to an embodiment of the present disclosure.

FIG. 10 is a schematic flowchart of another method for determining a duration according to an embodiment of the present disclosure.

FIG. 11 is a block diagram of a terminal apparatus according to an embodiment of the present disclosure.

FIG. 12 is a block diagram of a base station apparatus according to an embodiment of the present disclosure.

FIG. 13 is a structural schematic diagram of a communication apparatus according to an embodiment of the present disclosure of the present disclosure.

FIG. 14 is a structural schematic diagram of another communication apparatus according to an embodiment of the present disclosure of the present disclosure.

FIG. 15 is a structural schematic diagram of a communication system according to an embodiment of the present disclosure of the present disclosure.

### DETAILED DESCRIPTION

Reference will now be made in detail to embodiments of the present disclosure, examples of which are illustrated in the accompanying drawings. When the following description refers to the accompanying drawings, unless otherwise indicated, the same numbers in different accompanying drawings indicate the same or similar elements. Implementations described in the following embodiments of the present disclosure do not represent all implementations consistent with the present disclosure. Rather, they are merely examples of apparatuses and methods consistent with some aspects of the present disclosure as detailed in the appended claims.

Terms used in the present disclosure are only for a purpose of describing specific embodiments, and are not limiting the present disclosure. Singular forms of “a,” said,” and “the” used in the present disclosure and in the claims are also intended to include majority forms, unless the context clearly indicates otherwise. It should also be understood that the term “and/or” as used herein refers to any or all of the possible combinations containing at least one of the listed items in association.

It should be understood that although terms first, second, third, etc. may be used to describe various messages in the present disclosure, these messages should not be limited to these terms. These terms are only used to distinguish messages of the same type from each other. For example, without departing from the scope of the present disclosure, the first message may also be named as a second message, and similarly, the second message may be named as a first message. Depending on the context, the word “if” as used herein can be interpreted as “at” or “when” or “in response to determining”.

In an NTN, the long distance between satellites and ground terminals results in significant path loss, leading to limited coverage for some channels. At present, the uplink coverage can be improved by joint channel estimation.

The joint channel estimation can refer to joint channel estimation of multiple channels. During implementation, the number of channels for joint channel estimation each time is determined by the number of DMRS bindings. That is, the number of joint channel estimation windows defines the number of channels when joint channel estimation is performed.

A prerequisite for the use of DMRS bundling is that the terminal is able to guarantee power consistency and phase consistency over a period of uplink transmission time. According to relevant mechanisms, the requirement for phase continuity is satisfied when a phase difference between two slots is no more than 25 degrees or 30 degrees.

The phase is calculated using the formula:

$$Phase Phi = 2 π \times v \times t / λ = 2 π \times f d \times t$$

Where t is a difference between two time points, i.e. the duration, v refers to a relative movement speed of a transmitter and a receiver, λ is a propagation speed of a beam, and fd is a Doppler frequency shift.

It can be seen that in addition to the phase noise caused by devices, the relative movement between the transmitter and receiver also causes phase shifts.

When performing uplink coverage enhancement, the terminal needs to ensure power consistency and phase continuity within a certain time window. Therefore, it is necessary for the terminal to report this capability, i.e., the maximum span for the terminal to maintain power consistency and phase consistency. The base station can configure a duration L for joint channel estimation through Radio Resource Control (RRC) messages, where L cannot exceed the maximum span and can be configured separately for Physical Uplink Shared Channel (PUSCH) and Physical Uplink Control Channel (PUCCH), and each UpLink (UL) Bandwidth Part (BWP) can also be configured with L respectively. When L is not configured, it can be defaulted that L can be a minimum of a maximum span and a maximum repetition transmission duration, i.e., L=min (maximum span, maximum repetition transmission duration).

However, in the NTN, due to the high mobility of satellites, the terminal cannot guarantee power consistency and phase consistency throughout the entire maximum span. Therefore, in the NTN, the reliability of uplink coverage enhancement through joint channel estimation is low.

In order to solve this technical problem, the present disclosure provides the following duration determination method and apparatus, storage medium, and communication system, which can dynamically determine the duration of joint channel estimation by a terminal and a base station in an NTN network, realize the purpose of enhancing the coverage of the uplink channel in the NTN network, and improve the reliability of the uplink transmission in the NTN network.

First, the method for determining a duration provided by the present disclosure will be introduced from a terminal side.

An embodiment of the present disclosure provides a method for determining a duration, referring to FIG. 1, FIG. 1 is a flowchart of a method for determining a duration according to an embodiment, which can be performed by a terminal, and the method may include the following steps.

In step 101, determining a first duration, where the first duration is a maximum span supported by the terminal for performing joint channel estimation on uplink channel.

In an embodiment of the present disclosure, the terminal may determine a maximum span the terminal to support joint channel estimation for uplink channel based on a terminal capability. That is, the terminal may determine a maximum span for which the terminal is capable of maintaining power consistency and/or phase consistency based on the terminal capability.

In a possible implementation, the terminal may determine a maximum span the terminal to support joint channel estimation for a specific uplink channel based on the terminal capability. The specific uplink channel may be a PUSCH and/or a PUCCH.

In another possible implementation, the terminal may determine a maximum span for the terminal to support joint channel estimation for a specific transmission mode of a specific uplink channel based on the terminal capability. The specific uplink channel may be a PUSCH and/or a PUCCH, and the specific transmission mode may include but not limited to a typeA repetition transmission mode for PUSCH, a typeB repetition transmission method for PUSCH, etc.

In step 102, reporting the first duration to a base station.

In a possible implementation, the terminal may report the first duration to the base station through an RRC message.

In step 103, determining a second duration for performing joint channel estimation on uplink channel, where the second duration is less than or equal to the first duration.

In a possible implementation, after the terminal reports the first duration to the base station, the base station determines a length L of the Time Domain Window (TDW) for binding a demodulation reference signal (DMRS) based on the first duration. L is a binding duration of the demodulation reference signal (DMRS), which can be less than or equal to the first duration.

Furthermore, the binding duration of the demodulation reference signal (DMRS) may be issued by the base station.

In an example, the base station may send at least one binding duration to the terminal through an RRC message, and the at least one binding duration is less than or equal to the first duration.

Further, the terminal may determine the second duration based on the at least one binding duration.

In an example, the number of binding durations sent by the base station to the terminal is 1, and the terminal can determine the second duration less than or equal to the one binding duration according to a service situation, a channel quality between the terminal and the network-side device, etc.

In another example, the number of binding durations sent by the base station to the terminal is a plurality, and the terminal may determine one of the plurality of binding durations as the second duration according to the service situation, the channel quality between the terminal and the network-side device, etc.

In another possible implementation, the terminal may directly determine a second duration less than or equal to the first duration based on the first duration reported to the base station, and according to the service situation, the channel quality between the terminal and the network-side device, etc.

In step 104, determining that the second duration takes effect.

In an embodiment of the present disclosure, the terminal determining that the second duration takes effect may include, but is not limited to, at least one of the following: determining an effective starting moment of the second duration; or determining an effective range of the second duration. The method of determining the effective starting moment and effective range will be introduced in the following embodiments, and will not be introduced here for the time being.

In the above embodiments, the duration of joint channel estimation can be dynamically determined in the NTN network, thus achieving the purpose of enhancing the coverage of the uplink channel in the NTN network, and improving the reliability of the uplink transmission in the NTN network.

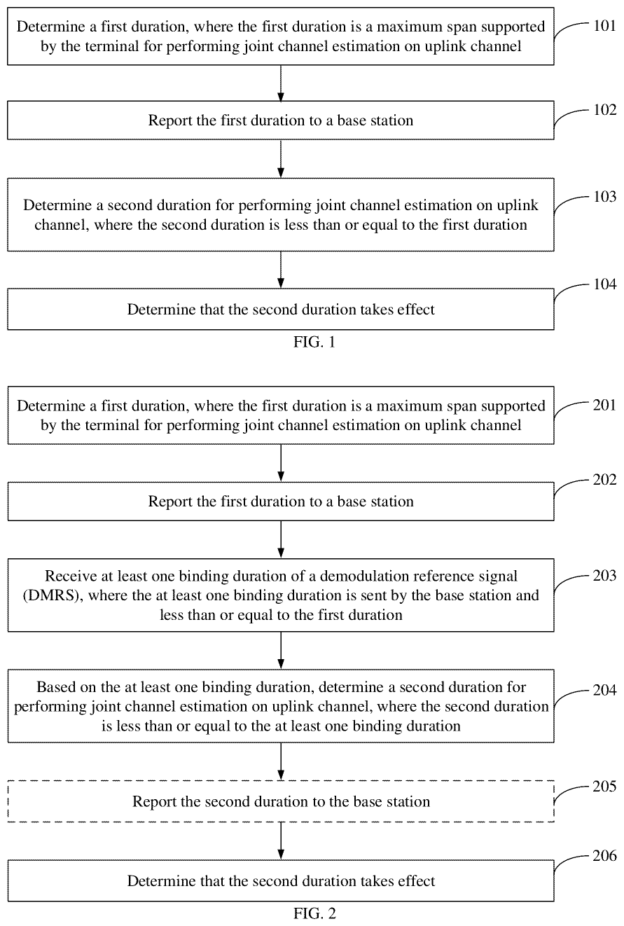

In some embodiments, with reference to FIG. 2, FIG. 2 is a flowchart of a method for determining a duration according to an embodiment, which can be performed by a terminal, and the method may include the following steps.

In step 201, determining a first duration, where the first duration is a maximum span supported by the terminal for performing joint channel estimation on uplink channel.

In an embodiment of the present disclosure, the terminal may determine a maximum span the terminal to support joint channel estimation for uplink channel based on a terminal capability. That is, the terminal may determine a maximum span for which the terminal is capable of maintaining power consistency and/or phase consistency based on the terminal capability.

In a possible implementation, the terminal may determine a maximum span the terminal to support joint channel estimation for a specific uplink channel based on the terminal capability. The specific uplink channel may be a PUSCH or a PUCCH.

In another possible implementation, the terminal may determine a maximum span for the terminal to support joint channel estimation for a specific transmission mode of a specific uplink channel based on the terminal capability. The specific uplink channel may be a PUSCH and/or a PUCCH, and the specific transmission mode may include but not limited to a typeA repetition transmission mode for PUSCH, a typeB repetition transmission method for PUSCH, etc.

In step 202, reporting the first duration to a base station.

In a possible implementation, the terminal may report the first duration to the base station through an RRC message.

In step 203, receiving at least one binding duration of a demodulation reference signal (DMRS), where the at least one binding duration is sent by the base station and less than or equal to the first duration.

In an embodiment of the present disclosure, after the terminal reports the first duration to the base station, the base station determines a length L of the TDW for binding a demodulation reference signal (DMRS) based on the first duration. L is a binding duration of the demodulation reference signal (DMRS), which can be less than or equal to the first duration.

Furthermore, the binding duration of the demodulation reference signal (DMRS) may be issued by the base station.

In an example, the base station may send the at least one binding duration to the terminal through an RRC message, and the at least one binding duration is less than or equal to the first duration.

In step 204, based on the at least one binding duration, determining a second duration for performing joint channel estimation on uplink channel, where the second duration is less than or equal to the at least one binding duration.

In an example, the number of binding durations sent by the base station to the terminal is 1, and the terminal can determine the second duration equal to the one binding duration according to a service situation, a channel quality between the terminal and the network-side device, etc.

In another example, the number of binding durations sent by the base station to the terminal is 1, and the terminal can determine the second duration less than the one binding duration according to a service situation, a channel quality between the terminal and the network-side device, etc.

In another example, the number of binding durations sent by the base station to the terminal is a plurality, and the terminal may determine one of the plurality of binding durations as the second duration according to the service situation, the channel quality between the terminal and the network-side device, etc.

For example, the plurality of binding durations include L1, L2, L3, L4, and the terminal may determine one of them, assuming L2, as the second duration.

In step 205, reporting the second duration to the base station.

In a possible implementation, the terminal may report the second duration to the base station through first Uplink Control Information (UCI).

In an example, a value indicated by a bit value of a first information field in the first UCI is equal to the second duration.

The first information field may be an information field for indicating the second duration, or the first information field may be an information field for indicating whether the second duration takes effect. Specifically, the first information field may be a dedicated field agreed upon in a protocol for indicating the second duration or to indicate whether the second duration takes effect, or the first information field may multiplex an information field used for transmitting other information, which is not limited in the present disclosure.

In an embodiment of the present disclosure, a value indicated by a bit value of a first information field in the first UCI may be equal to the second duration.

For example, the second duration is t milliseconds, and the value indicated by the bit value of the first information field in the first UCI is t.

In another example, the value indicated by the bit value of the first information field in the first UCI may be equal to an index value of the second duration, thereby reducing the number of bits occupied by the UCI, saving uplink signaling resources, and achieving high availability.

For example, the base station sends a plurality of binding durations to the terminal, including L1, L2, L3, and L4. The terminal determines that the second duration is L2. The value indicated by the bit value of the first information field in the first UCI is the index value of the second duration. Here, the index value of the second duration is 2. Therefore, the value indicated by the bit value of the first information field in the first UCI is also 2.

The above is only an exemplary explanation. In practical applications, any solution that reports the second duration for performing joint channel estimation on uplink channel, dynamically determined by the terminal and reported to the base station through UCI, should fall within the protection scope of the present disclosure.

In another possible implementation, the terminal may report the second duration to the base station through a first media access control element (MAC CE).

Similarly, the bit value included in the first MAC CE may directly indicate the second duration, or an index value indicating the second duration, which is not limited by the present disclosure.

It can be understood that step 205 is an optional step.

In a possible implementation, if the number of binding durations is 1 and the terminal determines that the second duration is equal to the one binding duration, step 205 may be omitted, that is, the terminal does not need to report the second duration to the base station. When the number of binding durations is 1 and the second duration reported by the terminal is not received, the base station can determine that the second duration is equal to the one binding duration.

In another possible implementation, the number of binding durations is 1, and an optional duration set is determined through protocol agreement or pre-negotiation between the base station and the terminal, which includes at least one optional duration. After receiving the one binding duration sent by the base station, the terminal selects an optional duration from the optional duration set according to predefined rules, and determines a difference between the one binding duration and the selected optional duration as the second duration. At this time, step 205 may also be omitted, that is, the terminal may not report the second duration to the base station.

In another possible implementation, the number of binding durations is a plurality, and the way to determine the second duration among the plurality of binding durations is determined through protocol agreement or pre-negotiation between the base station and the terminal, then step 205 may also be omitted, that is, the terminal may not report the second duration to the base station.

In step 206, determining that the second duration takes effect.

In an embodiment of the present disclosure, the terminal determining that the second duration takes effect may include, but is not limited to, at least one of the following: determining an effective starting moment of the second duration; or determining an effective range of the second duration. The method of determining the effective starting moment and effective range will be introduced in the following embodiments, and will not be introduced here for the time being.

In the above embodiment, the terminal can determine the second duration for performing joint channel estimation on uplink channel based on the binding duration of the demodulation reference signal (DMRS) sent by the base station, and then determine that the second duration takes effect, so that in the NTN network, the duration of joint channel estimation can be dynamically determined, the purpose of enhancing the coverage of the uplink channel in the NTN network is achieved, and the reliability of the uplink transmission in the NTN network is improved.

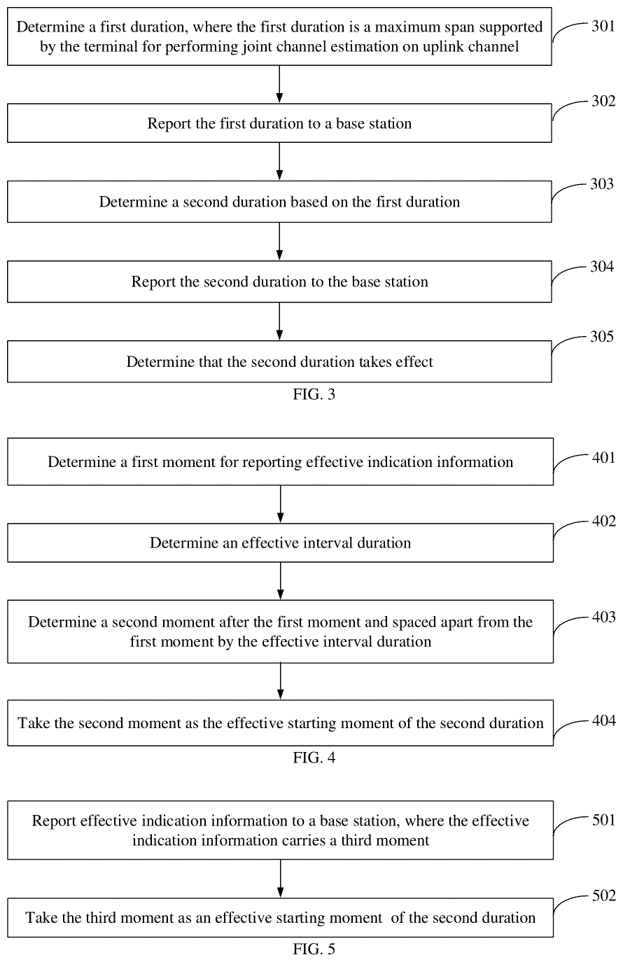

In some embodiments, with reference to FIG. 3, FIG. 3 is a flowchart of a method for determining a duration according to an embodiment, which can be performed by a terminal, and the method may include the following steps.

In step 301, determining a first duration, where the first duration is a maximum span supported by the terminal for performing joint channel estimation on uplink channel.

In an embodiment of the present disclosure, the terminal may determine a maximum span the terminal to support joint channel estimation for uplink channel based on a terminal capability. That is, the terminal may determine a maximum span for which the terminal is capable of maintaining power consistency and/or phase consistency based on the terminal capability.

In a possible implementation, the terminal may determine a maximum span the terminal to support joint channel estimation for a specific uplink channel based on the terminal capability. The specific uplink channel may be a PUSCH or a PUCCH.

In another possible implementation, the terminal may determine a maximum span for the terminal to support joint channel estimation for a specific transmission mode of a specific uplink channel based on the terminal capability. The specific uplink channel may be a PUSCH and/or a PUCCH, and the specific transmission mode may include but not limited to a typeA repetition transmission mode for PUSCH, a typeB repetition transmission method for PUSCH, etc.

In step 302, reporting the first duration to a base station.

In a possible implementation, the terminal may report the first duration to the base station through an RRC message.

In step 303, determining a second duration based on the first duration.

In the embodiment of the present disclosure, the terminal may directly determine a second duration less than or equal to the first duration based on the first duration reported to the base station, and according to the service situation, the channel quality between the terminal and the network-side device, etc.

In step 304, reporting the second duration to the base station.

In a possible implementation, the terminal may report the second duration to the base station through first UCI.

In an example, a value indicated by a bit value of a first information field in the first UCI is equal to the second duration.

The first information field may be an information field for indicating the second duration, or the first information field may be an information field for indicating whether the second duration takes effect. Specifically, the first information field may be a dedicated field agreed upon in a protocol for indicating the second duration or to indicate whether the second duration takes effect, or the first information field may multiplex an information field used for transmitting other information, which is not limited in the present disclosure.

In an embodiment of the present disclosure, a value indicated by a bit value of a first information field in the first UCI may be equal to the second duration.

In another example, the value indicated by the bit value of the first information field in the first UCI may be equal to an index value of the second duration, thereby reducing the number of bits occupied by the UCI, saving uplink signaling resources, and achieving high availability.

The above is only an exemplary explanation. In practical applications, any solution that reports the second duration for performing joint channel estimation on uplink channel, dynamically determined by the terminal and reported to the base station through UCI, should fall within the protection scope of the present disclosure.

In another possible implementation, the terminal may report the second duration to the base station through the first MAC CE.

Similarly, the bit value included in the first MAC CE may directly indicate the second duration, or an index value indicating the second duration, which is not limited by the present disclosure.

In step 305, determining that the second duration takes effect.

In an embodiment of the present disclosure, the terminal determining that the second duration takes effect may include, but is not limited to, at least one of the following: determining an effective starting moment of the second duration; or determining an effective range of the second duration. The method of determining the effective starting moment and effective range will be introduced in the following embodiments, and will not be introduced here for the time being.

In the above embodiment, the terminal can directly determine the second duration for performing joint channel estimation on uplink channel based on the first duration, and then determine that the second duration takes effect, so that in the NTN network, the duration of joint channel estimation can be dynamically determined, the purpose of enhancing the coverage of the uplink channel in the NTN network is achieved, and the reliability of the uplink transmission in the NTN network is improved.

In some embodiments, determining that the second duration takes effect includes: determining an effective starting moment of the second duration.

Specifically, the following methods can be adopted to determine the effective starting moment of the second duration:

In the first method, the effective starting moment of the second duration is determined based on the first moment when the terminal reports effective indication information and an effective interval duration.

Referring to FIG. 4, FIG. 4 is a flowchart of a method for determining a duration according to an embodiment, which can be performed by a terminal, and the method may include the following steps.

In step 401, determining a first moment for reporting effective indication information.

In an embodiment of the present disclosure, the terminal may report effective indication information to the base station, where the effective indication information indicates that the second duration takes effect. The terminal determines the first moment for reporting the effective indication information.

In a possible implementation, the effective indication information may indicate that the terminal supports maintaining power consistency and/or phase continuity within the second duration.

In a possible implementation, the effective indication information may be reported to the base station through second UCI.

In some examples, the second UCI may be the same UCI as the first UCI, that is, the terminal reports the second duration and the effective indication information to the base station through the same UCI.

Specifically, the terminal may report the second duration to the base station through a first information field, and report the effective indication information to the base station through a second information field in the same UCI.

The first information field may be an information field for indicating the second duration, or the first information field may be an information field for indicating whether the second duration takes effect. Specifically, the first information field may be a dedicated field agreed upon in a protocol for indicating the second duration or to indicate whether the second duration takes effect, or the first information field may multiplex an information field used for transmitting other information, which is not limited in the present disclosure.

The second information field may be an information field for indicating whether the second duration takes effect. Correspondingly, the second information field may be the same information field or different information field from the first information field, which is not limited by the present disclosure.

In an example, a value indicated by a bit value of the first information field is equal to the second duration, or the value indicated by the bit value of the first information field is equal to the index value of the second duration, i.e., if the bit value of the first information field is used to indicate a valid value, the terminal determines to report the effective indication information to the base station.

In another example, a value indicated by a bit value of a first information field in UCI is equal to the second duration, or the value indicated by the bit value of the first information field is equal to the index value of the second duration, and a bit value of a second information field in the same UCI is used to indicate that the second duration takes effect.

In some examples, the second UCI may be a different UCI from the first UCI, that is, the terminal reports the second duration and the effective indication information to the base station through different UCIs.

In another possible implementation, the terminal may report the effective indication information to the base station through a second MAC CE.

In some examples, the second MAC CE and the first MAC CE may be the same MAC CE or may be different MAC CEs, which is not limited by the present disclosure.

In step 402, determining an effective interval duration.

In an embodiment of the present disclosure, the second duration may not take effect immediately at the first moment when the terminal reports the effective indication information, so it is necessary to determine a duration offset, that is, the effective interval duration, on the basis of the first moment. The effective interval duration refers to a duration of the interval from the first moment for reporting the effective indication information to an effective starting moment of the second duration.

In a possible implementation, the effective interval duration may be determined based on a protocol agreement.

In another possible implementation, the effective interval duration may be determined by the terminal, and further, the terminal can report the effective interval duration to the base station while reporting the effective indication information.

It can be understood that the terminal can report the effective indication information and the effective interval duration to the base station through the same UCI or the same MAC CE.

Of course, the effective interval duration can also be determined by the base station side, which is not limited by the present disclosure.

In step 403, determining a second moment after the first moment and spaced apart from the first moment by the effective interval duration.

For example, if the first moment is t₁ and the effective interval duration is t′, the second moment is t₂=t₁+t′.

In step 404, taking the second moment as the effective starting moment of the second duration.

In the above embodiment, the terminal can dynamically determine the effective starting moment of the second duration based on the first moment when the terminal reports effective indication information and the effective interval duration. This achieves the purpose of dynamically determining the duration of joint channel estimation in the NTN network. The present disclosure can enhance the coverage of the uplink channel in the NTN network, thereby improving the reliability of the uplink transmission in the NTN network.

In the second method, a third moment carried in the effective indication information is determined as the effective starting moment of the second duration.

Referring to FIG. 5, FIG. 5 is a flowchart of a method for determining a duration according to an embodiment, which can be performed by a terminal, and the method may include the following steps.

In step 501, reporting effective indication information to a base station, where the effective indication information carries a third moment.

In an embodiment of the present disclosure, the terminal may report effective indication information to the base station, where the effective indication information indicates that the second duration takes effect, and the effective indication information carries the third moment.

In a possible implementation, the effective indication information may indicate that the terminal supports maintaining power consistency and/or phase continuity within the second duration.

In a possible implementation, the effective indication information may be reported to the base station through second UCI.

In some examples, the second UCI may be the same UCI as the first UCI, that is, the terminal reports the second duration and the effective indication information to the base station through the same UCI.

Specifically, the terminal may report the second duration to the base station through a first information field, and report the effective indication information to the base station through a second information field in the same UCI.

The first information field may be an information field for indicating the second duration, or the first information field may be an information field for indicating whether the second duration takes effect. Specifically, the first information field may be a dedicated field agreed upon in a protocol for indicating the second duration or to indicate whether the second duration takes effect, or the first information field may multiplex an information field used for transmitting other information, which is not limited in the present disclosure.

The second information field may be an information field for indicating whether the second duration takes effect. Correspondingly, the second information field may be the same information field or different information field from the first information field, which is not limited by the present disclosure.

In an example, a value indicated by a bit value of the first information field is equal to the second duration, or the value indicated by the bit value of the first information field is equal to the index value of the second duration, i.e., if the bit value of the first information field is used to indicate a valid value, the terminal determines to report the effective indication information to the base station.

In another example, a value indicated by a bit value of a first information field in UCI is equal to the second duration, or the value indicated by the bit value of the first information field is equal to the index value of the second duration, and a bit value of a second information field in the same UCI is used to indicate that the second duration takes effect.

In some examples, the second UCI may be a different UCI from the first UCI, that is, the terminal reports the second duration and the effective indication information to the base station through different UCIs.

In another possible implementation, the terminal may report the effective indication information to the base station through a second MAC CE.

In some examples, the second MAC CE and the first MAC CE may be the same MAC CE or may be different MAC CEs, which is not limited by the present disclosure.

In step 502, taking the third moment as an effective starting moment of the second duration.

In the above embodiment, the third moment carried in the effective indication information can be taken as the effective starting moment of the second duration, thus achieving the purpose of dynamically determining the duration of joint channel estimation in the NTN network. The present disclosure can enhance the coverage of the uplink channel in the NTN network, thereby improving the reliability of the uplink transmission in the NTN network.

In some embodiments, determining that the second duration takes effect includes: determining an effective range of the second duration.

In a possible implementation, a period from the effective starting moment of the second duration to an effective starting moment of a new second duration may be determined as the effective range of the second duration.

Specifically, the new second duration may not be equal to the second duration. That is, after the terminal determines the effective starting moment of the second duration, a period from the effective starting moment of the second duration to the effective starting moment of the new second duration determined by the terminal, can be used as the effective range of the second duration.

The method for determining the new second duration is similar to the method for determining the second duration in the above-mentioned embodiment, and the details are not repeated here. The method for determining the effective starting moment of the new second duration is similar to the method for determining the effective starting moment of the second duration in the above-mentioned embodiment, and will not be described here again.

For example, the effective starting moment of the second duration is t₂, and the effective starting moment of the new second duration is t₃, so the period from t₂ to t₃ can be taken as the effective range of the second duration.

In another possible implementation, a period from the effective starting moment of the second duration till completing a first number of uplink transmissions is determined as the effective range of the second duration.

The first number can be the number agreed upon in the protocol, or the first number can be determined by the terminal, or the first number can also be determined by the base station, and the present disclosure is not limited thereto.

The period from the effective starting moment of the second duration until the terminal completes the first number of uplink transmissions can be used as the effective range of the second duration.

For example, if the effective starting moment of the second duration is t₂, the first number is X, and X is a positive integer, and the terminal completes X uplink transmissions at moment t₄, then the terminal can determine the period from t₂ to t₄ as the effective range of the second duration.

In another possible implementation, a period from the effective starting moment of the second duration to an ineffective starting moment of the second duration is determined as the effective range of the second duration.

In an embodiment of the present disclosure, the terminal may report ineffective indication information to the base station, where the ineffective indication information is used for indicating that the second duration becomes ineffective.

In a possible implementation, the ineffective indication information further indicates that the terminal is unable to support continuing to maintain power consistency and/or phase continuity within the second duration.

In a possible implementation, the terminal may report the ineffective indication information to the base station through third UCI.

It should be noted that the third UCI may be the same UCI as the first UCI.

For example, the terminal may report the second duration through UCI, and report the ineffective indication information to the base station through the same UCI, so that the base station determines an expired second duration.

Of course, the third UCI may be a different UCI from the first UCI.

For example, the terminal may report the second duration through the first UCI. Furthermore, after a certain interval, if the terminal determines that the second duration becomes ineffective, it may report the ineffective indication information to the base station through the third UCI that is different from the first UCI.

In another possible implementation, the terminal may report the ineffective indication information to the base station through a third MAC CE.

It can be understood that the third MAC CE may be the same MAC CE or a different MAC CE from the first MAC CE, which is not limited by the present disclosure.

In an example, when the terminal reports the ineffective indication information through the third UCI, a bit value of a first information field in the third UCI can be set as an ineffectiveness value, where the ineffectiveness value includes but is not limited to all bits being 0, all bits being 1, or indicating a non-numerical value, such as a character string.

The character string may be “false”, “null”, etc., which is not limited by the present disclosure.

The first information field may be an information field for indicating the second duration, or the first information field may be an information field for indicating whether the second duration takes effect. Specifically, the first information field may be a dedicated field agreed upon in a protocol for indicating the second duration or to indicate whether the second duration takes effect, or the first information field may multiplex an information field used for transmitting other information, which is not limited in the present disclosure.

In an embodiment of the present disclosure, the second duration may not expire at the same time when the ineffective indication information is reported, so the terminal may also determine an ineffective interval duration, which refers to a duration from a fourth moment when the ineffective indication information is reported to the ineffective starting moment of the second duration.

In an example, the ineffective interval duration may be determined based on a protocol agreement.

In another example, the ineffective interval duration may be determined by the terminal, and further, the terminal can report the ineffective interval duration to the base station while reporting the ineffective indication information.

It can be understood that the terminal can report the ineffective indication information and the ineffective interval duration to the base station through the same UCI or the same MAC CE.

Of course, the effective interval duration can also be determined by the base station side, which is not limited by the present disclosure.

The terminal can determine a fifth moment, which is after the fourth moment and separated from the fourth moment by the ineffective interval duration, as the ineffective starting moment. The fourth moment is a moment when the terminal reports the ineffective indication information.

Or, when the terminal reports the ineffective indication information to the base station, the ineffective indication information can carry a sixth moment, and the terminal determines the sixth moment as the ineffective starting moment of the second duration.

In an implementation of the present disclosure, the terminal may determine a period from the effective starting moment of the second duration to an ineffective starting moment of the second duration from as the effective range of the second duration.

For example, the effective starting moment of the second duration is t₂, and the ineffective starting moment of the second duration is t₅, the terminal can determine the period from t₂ to t₅ as the effective range of the second duration.

In another possible implementation, the terminal may determine a period lasting for a third duration from the effective starting moment of the second duration as the effective range of the second duration.

In an example, the number of time units occupied by the third duration can be agreed by a protocol. The time unit may be a slot, a symbol, a span, etc., which is not limited in the present disclosure. A span includes a plurality of consecutive symbols.

In another example, the terminal can determine the number of time units occupied by the third duration and send a notification message to the base station, where the notification message is used to inform the base station of the number of time units occupied by the third duration. The time unit may be a slot, a symbol, a span, etc., which is not limited in the present disclosure. A span includes a plurality of consecutive symbols.

In some examples, the terminal may report the number of time units occupied by the second duration and the third duration to the base station through the same UCI or the same MAC CE.

In an embodiment of the present disclosure, the terminal may determine a period lasting for a third duration from the effective starting moment of the second duration as the effective range of the second duration.

For example, the effective starting moment of the second duration is t₂, the third duration occupies n slots, and the corresponding span is n, then the terminal can determine the effective range of the second duration from moment t₂ to moment (t₂+n).

The above is only an exemplary explanation, and other schemes for determining the effective range of the second duration should also fall within the protection scope of the present disclosure.

In the above embodiment, the terminal can quickly and effectively determine the effective range of the second duration, this achieves the purpose of dynamically determining the duration of joint channel estimation in the NTN network. The present disclosure can enhance the coverage of the uplink channel in the NTN network, thereby improving the reliability of the uplink transmission in the NTN network.

In some embodiments, determining that the second duration takes effect in the present disclosure may specifically include: determining that a joint channel estimation for an uplink channel takes effect within the second duration, and the uplink channel includes but is not limited to a PUSCH and/or a PUCCH.

Or, determining that the second duration takes effect in the present disclosure may specifically include: determining that a joint channel estimation for a first type of uplink channel takes effect within the second duration. Here, the first type of uplink channel may be a PUSCH, or the first type of uplink channel may be a PUCCH.

Or, determining that the second duration takes effect in the present disclosure may specifically include: determining that a joint channel estimation for a first transmission mode of the first type of uplink channel takes effect within the second duration.

Here, the first type of uplink channel can be a PUSCH, and the first transmission mode of the first type of uplink channel can be a typeA repetition transmission mode for PUSCH, a typeB repetition transmission method for PUSCH, etc.

In the above embodiments, the coverage of the uplink channel can be enhanced in the NTN network, improving the reliability of uplink transmission in the NTN network.

Next, the method for determining a duration provided by the present disclosure will be introduced from a base station side.

An embodiment of the present disclosure provides a method for determining a duration, referring to FIG. 6, FIG. 6 is a flowchart of a method for determining a duration according to an embodiment, which can be performed by a base station, and the method may include the following steps.

In step 601, receiving a first duration reported by a terminal, where the first duration is a maximum span supported by the terminal for performing joint channel estimation on uplink channel.

In a possible implementation, the base station may receive the first duration reported by the terminal to the base station through an RRC message.

In step 602, determining a second duration for performing joint channel estimation on uplink channel, where the second duration is less than or equal to the first duration.

In a possible implementation, after the terminal reports the first duration to the base station, the base station determines a length L of the TDW for binding a demodulation reference signal (DMRS) based on the first duration. L is a binding duration of the demodulation reference signal (DMRS), which can be less than or equal to the first duration.

Furthermore, the binding duration of the demodulation reference signal (DMRS) may be issued by the base station.

In an example, the base station may send at least one binding duration to the terminal through an RRC message, and the at least one binding duration is less than or equal to the first duration.

In an example, when the at least one binding duration includes one binding duration, and the second duration reported by the terminal is not received, the base station takes the one binding duration as the second duration.

In another example, when the at least one binding duration includes one binding duration, the base station receives the second duration reported by the terminal, which is determined by the terminal based on the one binding duration and is less than or equal to the one binding duration.

In another example, when the at least one binding duration is a plurality of binding durations, the base station may receive the second duration reported by the terminal, which is one of the plurality of binding durations.

In another possible implementation, after receiving the first duration reported by the terminal, the base station may directly receive the second duration reported by the terminal, where the second duration is determined by the terminal based on the first duration, and the second duration is less than or equal to the first duration.

In step 603, determining that the second duration takes effect.

In an embodiment of the present disclosure, the base station determining that the second duration takes effect may include, but is not limited to, at least one of the following: determining an effective starting moment of the second duration; or determining an effective range of the second duration. The method of determining the effective starting moment and effective range will be introduced in the following embodiments, and will not be introduced here for the time being.

In the above embodiments, the duration of joint channel estimation can be dynamically determined in the NTN network, thus achieving the purpose of enhancing the coverage of the uplink channel in the NTN network, and improving the reliability of the uplink transmission in the NTN network.

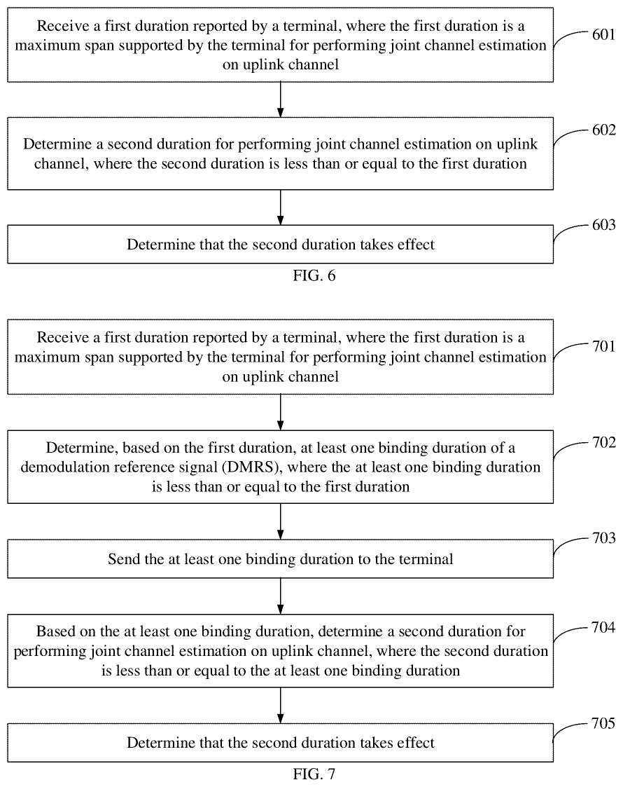

In some embodiments, with reference to FIG. 7, FIG. 7 is a flowchart of a method for determining a duration according to an embodiment, which can be performed by a base station, and the method may include the following steps.

In step 701, receiving a first duration reported by a terminal, where the first duration is a maximum span supported by the terminal for performing joint channel estimation on uplink channel.

In a possible implementation, the base station may receive the first duration reported by the terminal to the base station through an RRC message.

In step 702, determining, based on the first duration, at least one binding duration of a demodulation reference signal (DMRS), where the at least one binding duration is less than or equal to the first duration.

In an embodiment of the present disclosure, the base station may determine a length L of the TDW for binding a demodulation reference signal (DMRS) based on the first duration reported by the terminal. L is a binding duration of the demodulation reference signal (DMRS), which can be less than or equal to the first duration.

In step 703, sending the at least one binding duration to the terminal.

In an example, the base station may send the binding duration(s) to the terminal through an RRC message.

In an example, the number of the at least one binding duration may be 1.

In another example, the number of the at least one binding duration may be a plurality.

For example, the plurality of binding durations include L1, L2, L3, L4.

In step 704, based on the at least one binding duration, determining a second duration for performing joint channel estimation on uplink channel, where the second duration is less than or equal to the at least one binding duration.

In an example, when the at least one binding duration includes one binding duration, and the second duration reported by the terminal is not received, the base station takes the one binding duration as the second duration.

In another example, when the at least one binding duration includes one binding duration, the base station receives the second duration reported by the terminal, which is determined by the terminal based on the one binding duration and is less than or equal to the one binding duration.

In another example, when the at least one binding duration includes a plurality of binding durations, the base station may receive the second duration reported by the terminal, which is one of the plurality of binding durations.

In a possible implementation, the base station may receive the second duration reported by the terminal through first UCI.

In an example, a value indicated by a bit value of a first information field in the first UCI is equal to the second duration.

The first information field may be an information field for indicating the second duration, or the first information field may be an information field for indicating whether the second duration takes effect. Specifically, the first information field may be a dedicated field agreed upon in a protocol for indicating the second duration or to indicate whether the second duration takes effect, or the first information field may multiplex an information field used for transmitting other information, which is not limited in the present disclosure.

In an embodiment of the present disclosure, a value indicated by a bit value of a first information field in the first UCI may be equal to the second duration.

For example, the second duration is t milliseconds, and the value indicated by the bit value of the first information field in the first UCI is t.

In another example, the value indicated by the bit value of the first information field in the first UCI may be equal to an index value of the second duration, thereby reducing the number of bits occupied by the UCI, saving uplink signaling resources, and achieving high availability.

For example, the base station sends a plurality of binding durations to the terminal, including L1, L2, L3, and L4. The terminal determines that the second duration is L2. The value indicated by the bit value of the first information field in the first UCI is the index value of the second duration. Here, the index value of the second duration is 2. Therefore, the value indicated by the bit value of the first information field in the first UCI is also 2.

The above is only an exemplary explanation. In practical applications, any solution that reports the second duration for performing joint channel estimation on uplink channel, dynamically determined by the terminal and reported to the base station through UCI, should fall within the protection scope of the present disclosure.

In another possible implementation, the base station may receive the second duration reported by the terminal through a first MAC CE.

Similarly, the bit value included in the first MAC CE may directly indicate the second duration, or an index value indicating the second duration, which is not limited by the present disclosure.

In step 705, determining that the second duration takes effect.

In an embodiment of the present disclosure, after determining the second duration, the base station may determine that the second duration takes effect. The determining that the second duration takes effect may include, but is not limited to, at least one of the following: determining an effective starting moment of the second duration; or determining an effective range of the second duration.

The method of determining the effective starting moment and effective range will be introduced in the following embodiments, and will not be introduced here for the time being.

In the above embodiment, the second duration for performing joint channel estimation on uplink channel can be determined based on the binding duration of the demodulation reference signal (DMRS) determined by the base station, and then the second duration can be determined to take effect, so that in the NTN network, the duration of joint channel estimation can be dynamically determined, the purpose of enhancing the coverage of the uplink channel in the NTN network is achieved, and the reliability of the uplink transmission in the NTN network is improved.

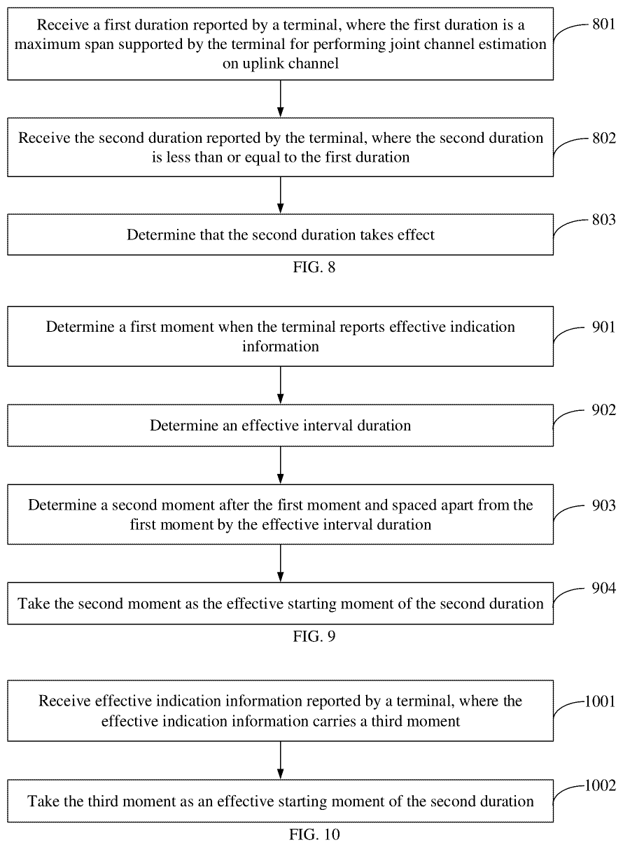

In some embodiments, with reference to FIG. 8, FIG. 8 is a flowchart of a method for determining a duration according to an embodiment, which can be performed by a base station, and the method may include the following steps.

In step 801, receiving a first duration reported by a terminal, where the first duration is a maximum span supported by the terminal for performing joint channel estimation on uplink channel.

In a possible implementation, the base station may receive the first duration reported by the terminal to the base station through an RRC message.

In step 802, receiving the second duration reported by the terminal, where the second duration is less than or equal to the first duration.

In an embodiment of the present disclosure, the second duration is determined by the terminal based on the first duration.

In a possible implementation, the base station may receive the second duration reported by the terminal through first UCI.

In an example, a value indicated by a bit value of a first information field in the first UCI is equal to the second duration.

The first information field may be an information field for indicating the second duration, or the first information field may be an information field for indicating whether the second duration takes effect. Specifically, the first information field may be a dedicated field agreed upon in a protocol for indicating the second duration or to indicate whether the second duration takes effect, or the first information field may multiplex an information field used for transmitting other information, which is not limited in the present disclosure.

In an embodiment of the present disclosure, a value indicated by a bit value of a first information field in the first UCI may be equal to the second duration.

For example, the second duration is t milliseconds, and the value indicated by the bit value of the first information field in the first UCI is t.

In another example, the value indicated by the bit value of the first information field in the first UCI may be equal to an index value of the second duration, thereby reducing the number of bits occupied by the UCI, saving uplink signaling resources, and achieving high availability.

In another possible implementation, the base station may receive the second duration reported by the terminal through a first MAC CE.

Similarly, the bit value included in the first MAC CE may directly indicate the second duration, or an index value indicating the second duration, which is not limited by the present disclosure.

In step 803, determining that the second duration takes effect.

In an embodiment of the present disclosure, after determining the second duration, the base station may determine that the second duration takes effect. The determining that the second duration takes effect may include, but is not limited to, at least one of the following: determining an effective starting moment of the second duration; or determining an effective range of the second duration.

The method of determining the effective starting moment and effective range will be introduced in the following embodiments, and will not be introduced here for the time being.

In the above embodiment, the terminal can directly determine the second duration for performing joint channel estimation on uplink channel based on the first duration, the base station can determine the second duration based on the report of the terminal, and then determine that the second duration takes effect, so that in the NTN network, the duration of joint channel estimation can be dynamically determined, the purpose of enhancing the coverage of the uplink channel in the NTN network is achieved, and the reliability of the uplink transmission in the NTN network is improved.

In some embodiments, determining that the second duration takes effect includes: determining an effective starting moment of the second duration.

Specifically, the following methods can be adopted to determine the effective starting moment of the second duration:

In the first method, the effective starting moment of the second duration is determined based on the first moment when the terminal reports effective indication information and an effective interval duration.

Referring to FIG. 9, FIG. 9 is a flowchart of a method for determining a duration according to an embodiment, which can be performed by a base station, and the method may include the following steps.

In step 901, determining a first moment when the terminal reports effective indication information.

In an embodiment of the present disclosure, the effective indication information indicates that the second duration takes effect. The base station determines the first moment when the terminal reports the effective indication information.

In a possible implementation, the effective indication information may indicate that the terminal supports maintaining power consistency and/or phase continuity within the second duration.

In a possible implementation, the base station may receive the effective indication information reported by the terminal through second UCI.

In some examples, the second UCI may be the same UCI as the first UCI, that is, the base station receives the second duration and the effective indication information reported by the terminal through the same UCI.

Specifically, the terminal may report the second duration to the base station through a first information field, and report the effective indication information to the base station through a second information field in the same UCI.

The first information field may be an information field for indicating the second duration, or the first information field may be an information field for indicating whether the second duration takes effect. Specifically, the first information field may be a dedicated field agreed upon in a protocol for indicating the second duration or to indicate whether the second duration takes effect, or the first information field may multiplex an information field used for transmitting other information, which is not limited in the present disclosure.

The second information field may be an information field for indicating whether the second duration takes effect. Correspondingly, the second information field may be the same information field or different information field from the first information field, which is not limited by the present disclosure.

In an example, a value indicated by a bit value of the first information field is equal to the second duration, or the value indicated by the bit value of the first information field is equal to the index value of the second duration, i.e., if the bit value of the first information field is used to indicate a valid value, the terminal determines to report the effective indication information to the base station.

In another example, a value indicated by a bit value of a first information field in UCI is equal to the second duration, or the value indicated by the bit value of the first information field is equal to the index value of the second duration, and a bit value of a second information field in the same UCI is used to indicate that the second duration takes effect.

In some examples, the second UCI may be a different UCI from the first UCI, that is, the terminal reports the second duration and the effective indication information to the base station through different UCIs.

In another possible implementation, the base station may receive the effective indication information reported by the terminal through a second MAC CE.

In some examples, the second MAC CE and the first MAC CE may be the same MAC CE or may be different MAC CEs, which is not limited by the present disclosure.

In step 902, determining an effective interval duration.

In an embodiment of the present disclosure, the second duration may not take effect immediately at the first moment when the terminal reports the effective indication information, so it is necessary to determine a duration offset, that is, the effective interval duration, on the basis of the first moment. The effective interval duration refers to a duration of the interval from the first moment for reporting the effective indication information to an effective starting moment of the second duration.

In a possible implementation, the base station may determine the effective interval duration based on a protocol agreement.

In another possible implementation, the effective interval duration receiving determined by the terminal, and further, the base station receives the effective interval duration reported by the terminal, and in some examples, the base station can receive the effective indication information and the effective interval duration simultaneously reported by the terminal.

It can be understood that the base station can receive the effective indication information and the effective interval duration reported by the terminal through the same UCI or the same MAC CE.

Of course, the effective interval duration can also be determined by the base station side, which is not limited by the present disclosure.

In step 903, determining a second moment after the first moment and spaced apart from the first moment by the effective interval duration.

For example, if the first moment is t₁ and the effective interval duration is t′, the second moment is t₂=t₁+t′.

In step 904, taking the second moment as the effective starting moment of the second duration.

In the above embodiment, the effective starting moment of the second duration can be dynamically determined based on the first moment when the terminal reports effective indication information and the effective interval duration. This achieves the purpose of dynamically determining the duration of joint channel estimation in the NTN network. The present disclosure can enhance the coverage of the uplink channel in the NTN network, thereby improving the reliability of the uplink transmission in the NTN network.

In the second method, a third moment carried in the effective indication information is determined as the effective starting moment of the second duration

Referring to FIG. 10, FIG. 10 is a flowchart of a method for determining a duration according to an embodiment, which can be performed by a base station, and the method may include the following steps.

In step 1001, receiving effective indication information reported by a terminal, where the effective indication information carries a third moment.

In an embodiment of the present disclosure, the base station may receive the effective indication information reported by the terminal, where the effective indication information indicates that the second duration takes effect, and the effective indication information carries the third moment.

In a possible implementation, the effective indication information may indicate that the terminal supports maintaining power consistency and/or phase continuity within the second duration.

In a possible implementation, the base station may receive the effective indication information reported by the terminal through second UCI.

In some examples, the second UCI may be the same UCI as the first UCI, that is, the terminal reports the second duration and the effective indication information to the base station through the same UCI.

Specifically, the base station may receive the second duration reported by the terminal through a first information field and the effective indication information reported through a second information field in the same UCI.

The first information field may be an information field for indicating the second duration, or the first information field may be an information field for indicating whether the second duration takes effect. Specifically, the first information field may be a dedicated field agreed upon in a protocol for indicating the second duration or to indicate whether the second duration takes effect, or the first information field may multiplex an information field used for transmitting other information, which is not limited in the present disclosure.

The second information field may be an information field for indicating whether the second duration takes effect. Correspondingly, the second information field may be the same information field or different information field from the first information field, which is not limited by the present disclosure.

In an example, a value indicated by a bit value of the first information field is equal to the second duration, or the value indicated by the bit value of the first information field is equal to the index value of the second duration, i.e., if the bit value of the first information field is used to indicate a valid value, the terminal determines to report the effective indication information to the base station.

In another example, a value indicated by a bit value of a first information field in UCI is equal to the second duration, or the value indicated by the bit value of the first information field is equal to the index value of the second duration, and a bit value of a second information field in the same UCI is used to indicate that the second duration takes effect.

In some examples, the second UCI may be a different UCI from the first UCI, that is, the terminal reports the second duration and the effective indication information to the base station through different UCIs.

In another possible implementation, the base station may receive the effective indication information reported by the terminal through a second MAC CE.

In some examples, the second MAC CE and the first MAC CE may be the same MAC CE or may be different MAC CEs, which is not limited by the present disclosure.

In step 1002, taking the third moment as an effective starting moment of the second duration.

In the above embodiment, the third moment carried in the effective indication information can be taken as the effective starting moment of the second duration, thus achieving the purpose of dynamically determining the duration of joint channel estimation in the NTN network. The present disclosure can enhance the coverage of the uplink channel in the NTN network, thereby improving the reliability of the uplink transmission in the NTN network.

In some embodiments, determining that the second duration takes effect includes: determining an effective range of the second duration.

In a possible implementation, a period from the effective starting moment of the second duration to an effective starting moment of a new second duration may be determined as the effective range of the second duration.

Specifically, the new second duration may not be equal to the second duration. That is, after the base station determines the effective starting moment of the second duration, a period from the effective starting moment of the second duration to the effective starting moment of the new second duration determined by the base station, can be used as the effective range of the second duration.

The method for determining the new second duration is similar to the method for determining the second duration in the above-mentioned embodiment, and the details are not repeated here. The method for determining the effective starting moment of the new second duration is similar to the method for determining the effective starting moment of the second duration in the above-mentioned embodiment, and will not be described here again.

In another possible implementation, a period from the effective starting moment of the second duration till completing a first number of uplink transmissions is determined as the effective range of the second duration.

The first number can be the number agreed upon in the protocol, or the first number can be determined by the terminal, or the first number can also be determined by the base station, and the present disclosure is not limited thereto.

The base station determines the period from the effective starting moment of the second duration until the terminal completes the first number of uplink transmissions as the effective range of the second duration.

In another possible implementation, a period from the effective starting moment of the second duration to an ineffective starting moment of the second duration is determined as the effective range of the second duration.

In an embodiment of the present disclosure, the base station may receive ineffective indication information reported by the terminal, where the ineffective indication information is used for indicating that the second duration becomes ineffective.

In a possible implementation, the ineffective indication information further indicates that the terminal is unable to support continuing to maintain power consistency and/or phase continuity within the second duration.

In a possible implementation, the base station may receive the ineffective indication information reported by the terminal through third UCI.

It should be noted that the third UCI may be the same UCI as the first UCI.

For example, the base station may receive the second duration reported by the terminal through UCI, and the same UCI further includes the ineffective indication information.

Of course, the third UCI may be a different UCI from the first UCI.

For example, the base station may receive the second duration reported by the terminal through the first UCI, and further, after a certain period of time, the base station may receive the ineffective indication information reported by the terminal through the third UCI different from the first UCI, and the base station determines that the second duration reported by the terminal becomes ineffective based on the ineffective indication information.

In another possible implementation, the base station may receive the ineffective indication information reported by the terminal through a third MAC CE.

It can be understood that the third MAC CE may be the same MAC CE or a different MAC CE from the first MAC CE, which is not limited by the present disclosure.

In an example, when the base station receives the ineffective indication information reported by the terminal through the third UCI, if it is determined that a bit value of a first information field in the third UCI is an ineffectiveness value, the base station determines that the ineffective indication information is received. The ineffectiveness value includes but is not limited to all bits being 0, all bits being 1, or indicating a non-numerical value, such as a character string. The character string may be “false”, “null”, etc., which is not limited by the present disclosure.

The first information field may be an information field for indicating the second duration, or the first information field may be an information field for indicating whether the second duration takes effect. Specifically, the first information field may be a dedicated field agreed upon in a protocol for indicating the second duration or to indicate whether the second duration takes effect, or the first information field may multiplex an information field used for transmitting other information, which is not limited in the present disclosure.

In an embodiment of the present disclosure, the second duration may not expire at the same time when the ineffective indication information is reported, so the base station may also determine an ineffective interval duration, which refers to a duration from a fourth moment when the ineffective indication information is reported to the ineffective starting moment of the second duration.

In an example, the ineffective interval duration may be determined based on a protocol agreement.

In another example, the ineffective interval duration may be determined by the terminal, and further, the base station can receive the ineffective indication information and the ineffective interval duration reported simultaneously by the terminal.

It can be understood that the base station can receive the ineffective indication information and the ineffective interval duration reported by the terminal through the same UCI or the same MAC CE.

Of course, the effective interval duration can also be determined by the base station side, which is not limited by the present disclosure.

The base station can determine a fifth moment, which is after the fourth moment and separated from the fourth moment by the ineffective interval duration, as the ineffective starting moment. The fourth moment is a moment when the terminal reports the ineffective indication information.

Or, the ineffective indication information may carry a sixth moment, and the base station determines the sixth moment as the ineffective starting moment of the second duration.

In an implementation of the present disclosure, the base station may determine a period from the effective starting moment of the second duration to an ineffective starting moment of the second duration from as the effective range of the second duration.

In another possible implementation, the base station may determine a period lasting for a third duration from the effective starting moment of the second duration as the effective range of the second duration.

In an example, the number of time units occupied by the third duration can be agreed by a protocol. The time unit may be a slot, a symbol, a span, etc., which is not limited in the present disclosure. A span includes a plurality of consecutive symbols.

In another example, the terminal can determine the number of time units occupied by the third duration and send a notification message to the base station, where the notification message is used to inform the base station of the number of time units occupied by the third duration. The time unit may be a slot, a symbol, a span, etc., which is not limited in the present disclosure. A span includes a plurality of consecutive symbols.

In some examples, the base station may receive the number of time units occupied by the second duration and the third duration reported by the terminal through the same UCI or the same MAC CE.

In an embodiment of the present disclosure, the base station may determine a period lasting for a third duration from the effective starting moment of the second duration as the effective range of the second duration.

The above is only an exemplary explanation, and other schemes for determining the effective range of the second duration should also fall within the protection scope of the present disclosure.

In the above embodiment, the effective range of the second duration can be quickly and effectively determined, this achieves the purpose of dynamically determining the duration of joint channel estimation in the NTN network. The present disclosure can enhance the coverage of the uplink channel in the NTN network, thereby improving the reliability of the uplink transmission in the NTN network.

In some embodiments, determining that the second duration takes effect in the present disclosure may specifically include: determining that a joint channel estimation for an uplink channel takes effect within the second duration, and the uplink channel includes but is not limited to a PUSCH and/or a PUCCH.

Or, determining that the second duration takes effect in the present disclosure may specifically include: determining that a joint channel estimation for a first type of uplink channel takes effect within the second duration. Here, the first type of uplink channel may be a PUSCH, or the first type of uplink channel may be a PUCCH.

Or, determining that the second duration takes effect in the present disclosure may specifically include: determining that a joint channel estimation for a first transmission mode of the first type of uplink channel takes effect within the second duration.

Here, the first type of uplink channel can be a PUSCH, and the first transmission mode of the first type of uplink channel can be a typeA repetition transmission mode for PUSCH, a typeB repetition transmission method for PUSCH, etc.

For ease of understanding, the solution of the present disclosure is further illustrated below with examples.

The present disclosure provides a method for dynamically determining a duration for performing joint channel estimation on uplink channel. The uplink channel may be a PUSCH or a PUCCH. Further, it can be a specific transmission mode for a specific channel, such as a PUSCH type A repetition transmission mode and a PUSCH type B repetition transmission mode.

In a possible implementation, in the present disclosure, a terminal may report its capability through an RRC message, that is, report a first duration to a base station, where the first duration is a maximum span supported by the terminal for performing joint channel estimation on uplink channel. The first duration may be a maximum span that the terminal supports maintaining power consistency and/or phase continuity.

The base station may send a length L of a TDW, i.e., a binding duration of a demodulation reference signal (DMRS), to the terminal through an RRC message.

The terminal may determine that the second duration for performing joint channel estimation on uplink channel is equal to the binding duration.

Further, the terminal may send effective indication information to the base station through second UCI or a second MAC CE, where the effective indication information indicates that the second duration takes effect.

Specifically, the effective indication information further indicates that the terminal supports maintaining power consistency and/or phase continuity within the second duration.

In another possible implementation, in the present disclosure, a terminal may report its capability through an RRC message, that is, report a first duration to a base station, where the first duration is a maximum span supported by the terminal for performing joint channel estimation on uplink channel. The first duration may be a maximum span that the terminal supports maintaining power consistency and/or phase continuity.

The base station may send a length L of a TDW, i.e., a binding duration of a demodulation reference signal (DMRS), to the terminal through an RRC message.

The terminal may determine that the second duration for performing joint channel estimation on uplink channel is equal to the binding duration.

Further, the terminal may send effective indication information to the base station through second UCI or a second MAC CE, where the effective indication information indicates that the second duration takes effect.

Specifically, the effective indication information further indicates that the terminal supports maintaining power consistency and/or phase continuity within the second duration. Further, the terminal may send ineffective indication information to the base station through third UCI or a third MAC CE, where the ineffective indication information is used for indicating that the second duration becomes ineffective.

Specifically, the ineffective indication information further indicates that the terminal no longer supports continuing to maintain power consistency and/or phase continuity within the second duration.

In another possible implementation, in the present disclosure, a terminal may report its capability through an RRC message, that is, report a first duration to a base station, where the first duration is a maximum span supported by the terminal for performing joint channel estimation on uplink channel. The first duration may be a maximum span that the terminal supports maintaining power consistency and/or phase continuity.

The base station may send a length L of a TDW, i.e., a binding duration of a demodulation reference signal (DMRS), to the terminal through an RRC message.

The terminal may determine a second duration Lx for performing joint channel estimation on uplink channel, and the second duration Lx may be less than or equal to the binding duration L.

Furthermore, the terminal may report the second duration Lx to the base station through first UCI or a first MAC CE. The terminal may also send effective indication information to the base station through second UCI or a second MAC CE, where the effective indication information indicates that the second duration takes effect.

The second UCI and the first UCI may be the same UCI or different UCIs, or the second MAC CE and the first MAC CE may be the same MAC CE or different MAC CEs, which is not limited in the present disclosure.

Specifically, the effective indication information further indicates that the terminal supports maintaining power consistency and/or phase continuity within the second duration.

For example, a value indicated by a bit value of a first information field in the first UCI is equal to the second duration, or the value indicated by the bit value of the first information field in the first UCI is equal to an index value of the second duration.

For example, the base station indicates a plurality binding durations through an RRC message, including L1, L2, L3 and L4, and the terminal can select one from {L1, L2, L3, L4}. Assuming that L2 is selected, the terminal can report a specific duration value of L2 to the base station through the first UCI or the first MAC CE, or can report an index value of L2.

In another possible implementation, in the present disclosure, a terminal may report its capability through an RRC message, that is, report a first duration to a base station, where the first duration is a maximum span supported by the terminal for performing joint channel estimation on uplink channel. The first duration may be a maximum span that the terminal supports maintaining power consistency and/or phase continuity.

The base station may send a length L of a TDW, i.e., a binding duration of a demodulation reference signal (DMRS), to the terminal through an RRC message.

The terminal may determine a second duration Lx for performing joint channel estimation on uplink channel, and the second duration Lx may be less than or equal to the binding duration L.

Furthermore, the terminal may report the second duration Lx to the base station through first UCI or a first MAC CE. The terminal may also send effective indication information to the base station through second UCI or a second MAC CE, where the effective indication information indicates that the second duration takes effect.

The second UCI and the first UCI may be the same UCI or different UCIs, or the second MAC CE and the first MAC CE may be the same MAC CE or different MAC CEs, which is not limited in the present disclosure.

Specifically, the effective indication information further indicates that the terminal supports maintaining power consistency and/or phase continuity within the second duration.

For example, a value indicated by a bit value of a first information field in the first UCI is equal to the second duration, or the value indicated by the bit value of the first information field in the first UCI is equal to an index value of the second duration.

Further, the terminal may send ineffective indication information to the base station through third UCI or a third MAC CE, where the ineffective indication information is used for indicating that the second duration becomes ineffective.

Specifically, the ineffective indication information further indicates that the terminal no longer supports continuing to maintain power consistency and/or phase continuity within the second duration.

The third UCI and the first UCI may be the same UCI or different UCIs, or the third MAC CE and the first MAC CE may be the same MAC CE or different MAC CEs, which is not limited in the present disclosure.

For example, when the terminal reports the second duration Lx to the base station through the first UCI, if a bit value of a first information field in the first UCI is set as a valid value, for example, a specific duration value of the second duration Lx or an index value of the second duration Lx, it can simultaneously indicate that the second duration takes effect. That is, the terminal only needs to report the second duration, so as to achieve the purpose of synchronously reporting the second duration and the effective indication information.

For example, when the terminal reports the second duration Lx to the base station through the first UCI, if a bit value of the first information field in the first UCI is set as an ineffectiveness value, for example, a specific duration value of the second duration Lx or an index value of the second duration Lx, it can simultaneously indicate that the second duration takes effect.

In another possible implementation, in the present disclosure, a terminal may report its capability through an RRC message, that is, report a first duration to a base station, where the first duration is a maximum span supported by the terminal for performing joint channel estimation on uplink channel. The first duration may be a maximum span that the terminal supports maintaining power consistency and/or phase continuity.

Furthermore, the terminal reports the second duration Lx to the base station through first UCI or a first MAC CE. The second duration is determined by the terminal based on the first duration, and the second duration is less than or equal to the first duration. The specific determination method has been introduced in the above embodiments, and will not be described here.

In the above implementation, both the terminal and the base station can determine that the second duration takes effect, including: determining an effective starting moment of the second duration; and/or determining an effective range of the second duration.

When determining the effective starting moment of the second duration, the effective starting moment of the second duration can be determined based on a first moment when the terminal reports the effective indication information and the effective interval duration, or a third moment carried in the effective indication information can be determined as the effective starting moment of the second duration.

When determining the effective range of the second duration, a period from the effective starting moment of the second duration to an effective starting moment of a new second duration can be determined as the effective range of the second duration, or a period from the effective starting moment of the second duration till completing a first number of uplink transmissions can be determined as the effective range of the second duration, or a period from the effective starting moment of the second duration to an ineffective starting moment of the second duration can be determined as the effective range of the second duration, or a period lasting for a third duration from the effective starting moment of the second duration can be determined as the effective range of the second duration.

The specific implementation can refer to the embodiments of the terminal side and the base station side, and will not be repeated here.

In the above embodiments, the duration of joint channel estimation can be dynamically determined in the NTN network, thus achieving the purpose of enhancing the coverage of the uplink channel in the NTN network, and improving the reliability of the uplink transmission in the NTN network.

Corresponding to the foregoing embodiments of the application function realization methods, the present disclosure further provides embodiments of application function realization apparatuses.

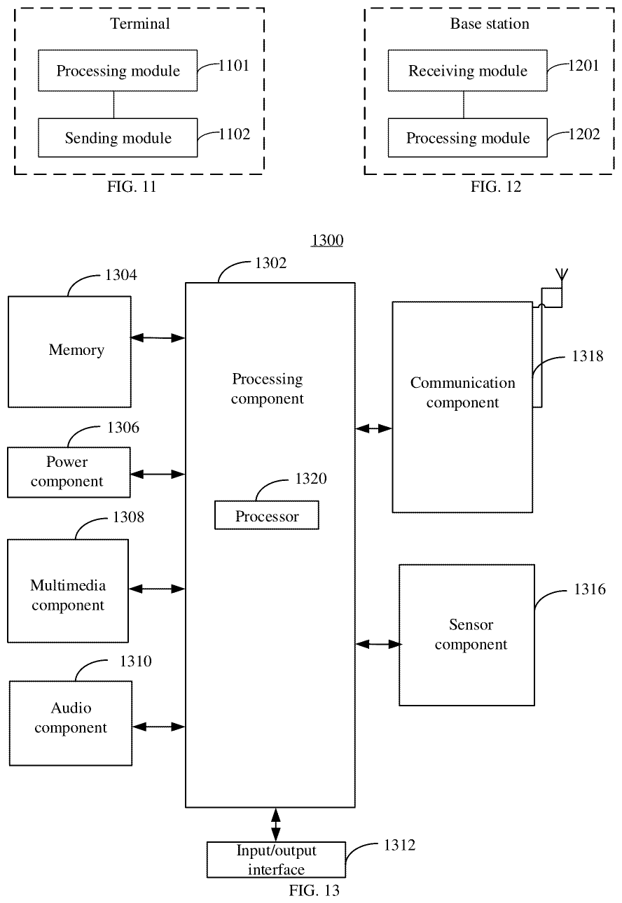

Referring to FIG. 11, FIG. 11 is a block diagram of a terminal according to an embodiment of the present disclosure, including:
a processing module 1101, configured to determine a first duration, where the first duration is a maximum span supported by the terminal for performing joint channel estimation on uplink channel;
a sending module 1102, configured to report the first duration to a base station;
the processing module 1101 is further configured to determine a second duration for performing joint channel estimation on uplink channel, where the second duration is less than or equal to the first duration; and
the processing module 1101 is further configured to determine that the second duration takes effect.

In some examples, the apparatus further includes:
a receiving module, configured to receive at least one binding duration of a demodulation reference signal (DMRS), where the at least one binding duration is sent by the base station and less than or equal to the first duration;
the processing module is further configured to perform any one of:
when the at least one binding duration includes one binding duration, determine the second duration to be less than or equal to the one binding duration; and
when the at least one binding duration includes a plurality of binding durations, determine one of the plurality of binding durations as the second duration.

In some examples, the processing module is further configured to:
determine the second duration based on the first duration.

In some examples, the sending module is further configured to:
report the second duration to the base station.

In some examples, the sending module is further configured to:
report the second duration to the base station through first uplink control information (UCI); or
report the second duration to the base station through a first media access control unit (MAC CE).

In some examples, a value indicated by a bit value of a first information field in the first UCI is equal to the second duration; or
the value indicated by the bit value of the first information field in the first UCI is equal to an index value of the second duration.

In some examples, the processing module is further configured to perform at least one of:
determine an effective starting moment of the second duration; or
determine an effective range of the second duration.

In some examples, the processing module is further configured to:
determine a first moment for reporting effective indication information, where the effective indication information indicates that the second duration takes effects;
determine an effective interval duration;
determine a second moment after the first moment and spaced apart from the first moment by the effective interval duration; and
take the second moment as the effective starting moment of the second duration.

In some examples, the processing module is further configured to:
determine a third moment carried in the effective indication information as the effective starting moment of the second duration, where the effective indication information indicates that the second duration takes effect.

In some examples, the processing module is further configured to perform any one of:
determine a period from the effective starting moment of the second duration to an effective starting moment of a new second duration as the effective range of the second duration;
determine a period from the effective starting moment of the second duration till completing a first number of uplink transmissions as the effective range of the second duration;
determine a period from the effective starting moment of the second duration to an ineffective starting moment of the second duration as the effective range of the second duration; and
determine a period lasting for a third duration from the effective starting moment of the second duration as the effective range of the second duration.

In some examples, the processing module is further configured to:
determine the number of time units occupied by the third duration based on a protocol agreement.

In some examples, the processing module is further configured to:
determine the number of time units occupied by the third duration;
the sending module is further configured to send a notification message to the base station, where the notification message is configured to inform the base station of the number of time units occupied by the third duration.

In some examples, the sending module is further configured to:
report effective indication information to the base station, where the effective indication information indicates that the second duration takes effect.

In some examples, the sending module is further configured to:
report the effective indication information to the base station through second uplink control information (UCI); or
report the effective indication information to the base station through a second media access control unit (MAC CE).

In some examples, the effective indication information further indicates that the terminal supports maintaining power consistency and/or phase continuity within the second duration.

In some examples, the sending module is further configured to:
report ineffective indication information to the base station, where the ineffective indication information is used for indicating that the second duration becomes ineffective.

In some examples, the sending module is further configured to:
report the ineffective indication information to the base station through third uplink control information (UCI); or
report the ineffective indication information to the base station through a third media access control unit (MAC CE).

In some examples, a bit value of a first information field in the third UCI indicates an ineffectiveness value.

In some examples, the ineffective indication information further indicates that the terminal is unable to support continuing to maintain power consistency or phase continuity or both within the second duration.

In some examples, the processing module is further configured to perform any one of:
determine that a joint channel estimation for an uplink channel takes effect within the second duration;
determine that a joint channel estimation for a first type of uplink channel takes effect within the second duration; and
determine that a joint channel estimation for a first transmission mode of the first type of uplink channel takes effect within the second duration.

Referring to FIG. 12, FIG. 12 is a block diagram of a base station according to an embodiment of the present disclosure, including:
a receiving module 1201, configured to receive a first duration reported by a terminal, where the first duration is a maximum span supported by the terminal for performing joint channel estimation on uplink channel;
a processing module 1202, configured to determine a second duration for performing joint channel estimation on uplink channel, where the second duration is less than or equal to the first duration; and
the processing module 1202 is further configured to determine that the second duration takes effect.

In some examples, the processing module is further configured to:
determine, based on the first duration, at least one binding duration of a demodulation reference signal (DMRS), where the at least one binding duration is less than or equal to the first duration;
the apparatus further includes:
a sending module, configured to send the at least one binding duration to the terminal;
the processing module is further configured to perform any one of:
when the at least one binding duration includes one binding duration, and the second duration reported by the terminal is not received, take the one binding duration as the second duration;
when the at least one binding duration includes one binding duration, receive the second duration reported by the terminal, where the second duration is less than or equal to the one binding duration; and
when the at least one binding duration includes a plurality of binding durations, receive the second duration reported by the terminal, where the second duration is one of the plurality of binding durations.

In some examples, the receiving module is further configured to:
receive the second duration reported by the terminal, where the second duration is determined by the terminal based on the first duration.

In some examples, the receiving module is further configured to:
receive the second duration reported by the terminal through first uplink control information (UCI); or
receive the second duration reported by the terminal through a first media access control unit (MAC CE).

In some examples, a value indicated by a bit value of a first information field in the first UCI is equal to the second duration; or
the value indicated by the bit value of the first information field in the first UCI is equal to an index value of the second duration.

In some examples, the processing module is further configured to perform at least one of:
determine an effective starting moment of the second duration; or
determine an effective range of the second duration.

In some examples, the processing module is further configured to:
determine a first moment when the terminal reports effective indication information, where the effective indication information indicates that the second duration takes effects;
determine an effective interval duration;
determine a second moment after the first moment and spaced apart from the first moment by the effective interval duration; and
take the second moment as the effective starting moment of the second duration.

In some examples, the processing module is further configured to:
determine a third moment carried in the effective indication information reported by the terminal as the effective starting moment of the second duration, where the effective indication information indicates that the second duration takes effect.

In some examples, the processing module is further configured to perform any one of:
determine a period from the effective starting moment of the second duration to an effective starting moment of a new second duration as the effective range of the second duration;
determine a period from the effective starting moment of the second duration till completing a first number of uplink transmissions as the effective range of the second duration;
determine a period from the effective starting moment of the second duration to an ineffective starting moment of the second duration as the effective range of the second duration;
and
determine a period lasting for a third duration from the effective starting moment of the second duration as the effective range of the second duration.

In some examples, the processing module is further configured to:
determine the number of time units occupied by the third duration based on a protocol agreement.

In some examples, the receiving module is further configured to:
receive a notification message reported by the terminal, where the notification message is configured to inform the base station of the number of time units occupied by the third duration.

In some examples, the receiving module is further configured to:
receive the effective indication information reported by the terminal, where the effective indication information indicates that the second duration takes effect.

In some examples, the receiving module is further configured to:
receive the effective indication information reported by the terminal through second uplink control information (UCI); or
receive the effective indication information reported by the terminal through a second media access control unit (MAC CE).

In some examples, the effective indication information further indicates that the terminal supports maintaining power consistency and/or phase continuity within the second duration.

In some examples, the receiving module is further configured to:
receive ineffective indication information reported by the terminal, where the ineffective indication information is used for indicating that the second duration becomes ineffective.

In some examples, the receiving module is further configured to:
receive the ineffective indication information reported by the terminal through third uplink control information (UCI); or
receive the ineffective indication information reported by the terminal through a third media access control unit (MAC CE).

In some examples, a bit value of a first information field in the third UCI indicates an ineffectiveness value.

In some examples, the ineffective indication information further indicates that the terminal is unable to support continuing to maintain power consistency or phase continuity or both within the second duration.

In some examples, the processing module is further configured to perform any of:
determine that a joint channel estimation for an uplink channel takes effect within the second duration;
determine that a joint channel estimation for a first type of uplink channel takes effect within the second duration; and
determine that a joint channel estimation for a first transmission mode of the first type of uplink channel takes effect within the second duration.

For the apparatus embodiment, because it basically corresponds to the method embodiment, it is only necessary to refer to the method embodiment for the relevant part of the description. The apparatus embodiments described above are only schematic, in which the units described above as separate components may or may not be physically separated, and the components displayed as units may or may not be physical units, that is, they may be located in one place or distributed to multiple network units. Some or all of the modules can be selected according to actual needs to achieve the purpose of the solution of the present disclosure. It can be understood and implemented by a person of ordinary skill in the art without creative labor.

Correspondingly, the present disclosure further provides a computer-readable storage medium, where the storage medium stores a computer program for executing any one of the methods for determining a duration described above in the terminal side.

Correspondingly, the present disclosure further provides a computer-readable storage medium, where the storage medium stores a computer program for executing any one of the methods for determining a duration described above in the base station side.

Correspondingly, the present disclosure further provides a communication apparatus, including:
a processor; and
a memory, configured to store processor-executable instructions;
where the processor is configured to execute any one of the methods for determining a duration described above in the terminal side.

FIG. 13 is a block diagram of a duration determining apparatus 1300 according to an embodiment of the present disclosure. For example, the apparatus 1300 may be a terminal such as a cell phone, a tablet computer, an e-book reader, a multimedia playback device, a wearable device, a vehicle user device, an ipad, a smart TV, and the like.

Referring to FIG. 13, the apparatus 1300 may include one or more of the following components: a processing component 1302, a memory 1304, a power component 1306, a multimedia component 1308, an audio component 1310, an input/output (I/O) interface 1312, a sensor component 1316, and a communication component 1318.

The processing component 1302 generally controls the overall operation of the apparatus 1300, such as operations associated with display, telephone call, data duration determination, camera operation and recording operation. The processing component 1302 may include one or more processors 1320 to execute instructions to complete all or part of steps of the above-mentioned method for determining a duration. In addition, the processing component 1302 may include one or more modules to facilitate interactions between the processing component 1302 and other components. For example, the processing component 1302 may include a multimedia module to facilitate interactions between the multimedia component 1308 and the processing component 1302. As another example, the processing component 1302 may read executable instructions from the memory to implement the steps of one of the methods for determining a duration provided in the above embodiments.

The memory 1304 is configured to store various types of data to support operations in the apparatus 1300. Examples of these data include instructions of any application program or method for being operated on the apparatus 1300, contact data, phone book data, messages, pictures, videos, etc. The memory 1304 can be implemented by any type of volatile or non-volatile memory device or combinations thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 1306 provides power to various components of the apparatus 1300. The power component 1306 may include a power management system, one or more power supplies, and other components associated with generating, managing and distributing power for the apparatus 1300.

The multimedia component 1308 includes a display screen that provides an output interface between the apparatus 1300 and a user. In some embodiments, the multimedia component 1308 includes a front camera and/or a rear camera. When the apparatus 1300 is in an operation mode, such as a shooting mode or a video mode, the front camera and/or the rear camera can receive external multimedia data. Each front camera and rear camera may be a fixed optical lens system or have focal length and optical zoom capability.

The audio component 1310 is configured to output and/or input audio signals. For example, the audio component 1310 includes a microphone (MIC) configured to receive external audio signals when the apparatus 1300 is in the operation mode, such as a calling mode, a recording mode and a voice recognition mode. The received audio signal may be further stored in the memory 1304 or transmitted via the communication component 1318. In some embodiments, the audio component 1310 further includes a speaker for outputting audio signals.

The I/O interface 1312 provides an interface between the processing component 1302 and peripheral interface modules, where the peripheral interface modules may be keyboards, click-wheels, buttons, etc. These buttons may include, but are not limited to: home button, volume button, start button and lock button.

The sensor component 1316 includes one or more sensors for providing various aspects of state evaluation for the apparatus 1300. For example, the sensor component 1316 can detect an on/off state of the apparatus 1300, a relative positioning of components, for example, the components are the display and the keypad of the apparatus 1300, and the sensor component 1316 can also detect a position change of the apparatus 1300 or a component of the apparatus 1300, presence or absence of user contact with the apparatus 1300, orientation or acceleration/deceleration of the apparatus 1300 and a temperature change of the apparatus 1300. The sensor component 1316 may include a proximity sensor configured to detect presence of a nearby object without any physical contact. The sensor component 1316 may also include an optical sensor, such as a CMOS or CCD image sensor, for use in imaging applications. In some embodiments, the sensor component 1316 may further include an acceleration sensor, a gyroscope sensor, a magnetic sensor, a pressure sensor or a temperature sensor.

The communication component 1318 is configured to facilitate wired or wireless communication between the apparatus 1300 and other devices. The apparatus 1300 can access a wireless network based on communication standards, such as Wi-Fi, 2G, 3G, 4G, 5G or 6G, or a combination thereof. In an embodiment of the present disclosure, the communication component 1318 receives a broadcast signal or broadcast related information from an external broadcast management system via a broadcast channel. In an embodiment of the present disclosure, the communication component 1318 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment of the present disclosure, the apparatus 1300 may be implemented by one or more application-specific integrated circuits (ASIC), digital signal processors (DSP), digital signal processing devices (DSPD), programmable logic devices (PLD), field programmable gate arrays (FPGA), controllers, micro-controllers, micro-processors or other electronic components, for executing any of the above-mentioned methods for determining a duration on the terminal side.

In an embodiment of the present disclosure, a non-transitory machine-readable storage medium is further provided, such as the memory 1304 including instructions, where the instructions can be executed by a processor 1320 of the apparatus 1300 to complete the above-mentioned method for determining a duration. For example, the non-transitory computer-readable storage medium may be an ROM, a random access memory (RAM), a CD-ROM, a magnetic tape, a floppy disk, an optical data storage device, etc.

Correspondingly, the present disclosure further provides a communication apparatus, including:
a processor; and
a memory, configured to store processor-executable instructions;
where the processor is configured to execute any one of the methods for determining a duration described above in the base station side.

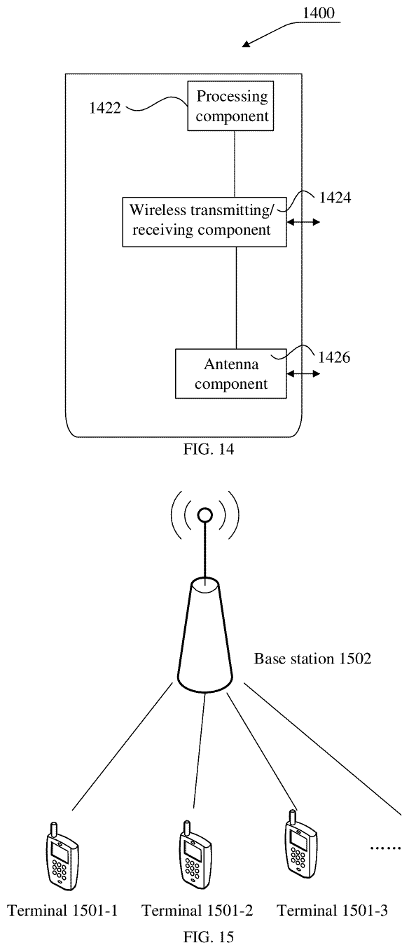

As shown in FIG. 14, FIG. 14 is a schematic structural diagram of a duration determination apparatus 1400 according to an embodiment of the present disclosure. The apparatus 1400 may be provided as a base station. Referring to FIG. 14, the apparatus 1400 includes a processing component 1422, a wireless transmitting/receiving component 1424, an antenna component 1426, and a signal processing part unique to a wireless interface, and the processing component 1422 may further include at least one processor.

One of the processors in the processing component 1422 may be configured to perform any of the above-mentioned methods for determining a duration.

Correspondingly, the present disclosure further provides a communication system, as shown in FIG. 15, FIG. 15 is a schematic structural diagram of a communication system according to an embodiment of the present disclosure, including:
a terminal 1501, configured to execute any one of the methods for determining a duration described above in the terminal side; and
a base station 1502, configured to execute any one of the methods for determining a duration described above in the base station side.

The present disclosure does not limit the number of terminals and base stations in the communication system.

Other embodiments of the present disclosure will easily occur to those skilled in the art after considering the specification and practicing the present disclosure disclosed herein. The present disclosure is intended to cover any variations, uses or adaptations of the present disclosure, and these variations, uses or adaptations follow general principles of the present disclosure and include common sense or common technical means in the technical field that are not disclosed in the present disclosure. The specification and embodiments are to be regarded as exemplary only, and true scope and spirit of the present disclosure are indicated by the following claims.

It should be understood that the present disclosure is not limited to precise structures described above and shown in the accompanying drawings, and various modifications and changes can be made without departing from its scope. The scope of the present disclosure is limited only by the appended claims.

1. A method for determining a duration, performed by a terminal and comprising:
determining a first duration, wherein the first duration is a maximum span supported by the terminal for performing joint channel estimation on uplink channel;
reporting the first duration to a base station;
determining a second duration for performing joint channel estimation on uplink channel, wherein the second duration is less than or equal to the first duration; and
determining that the second duration takes effect.

2. The method according to claim 1, further comprising:
receiving at least one binding duration of a demodulation reference signal (DMRS), wherein the at least one binding duration is sent by the base station and less than or equal to the first duration;
wherein the determining a second duration for performing joint channel estimation on uplink channel comprises one of:
when the at least one binding duration comprises one binding duration, determining the second duration to be less than or equal to the one binding duration; or
when the at least one binding duration comprises a plurality of binding durations, determining one of the plurality of binding durations as the second duration; and
determining the second duration based on the first duration.

3. (canceled)

4. The method according to claim 1, further comprising:
reporting the second duration to the base station through first uplink control information (UCI) or a first media access control unit (MAC CE);
wherein a value indicated by a bit value of a first information field in the first UCI is equal to the second duration; or the value indicated by the bit value of the first information field in the first UCI is equal to an index value of the second duration.

5. (canceled)

6. (canceled)

7. The method according to claim 1, wherein the determining that the second duration takes effect comprises at least one of:
determining an effective starting moment of the second duration; or
determining an effective range of the second duration.

8. The method according to claim 7, wherein the determining an effective starting moment of the second duration comprises one of:
determining a second moment after a first moment for reporting effective indication information and spaced apart from the first moment by an effective interval duration as the effective starting moment of the second duration; or
determining a third moment carried in the effective indication information as the effective starting moment of the second duration, wherein the effective indication information indicates that the second duration takes effect.

9. (canceled)

10. The method according to claim 8, wherein determining an effective range of the second duration comprises one of:
determining a period from the effective starting moment of the second duration to an effective starting moment of a new second duration as the effective range of the second duration;
determining a period from the effective starting moment of the second duration till completing a first number of uplink transmissions as the effective range of the second duration;
determining a period from the effective starting moment of the second duration to an ineffective starting moment of the second duration as the effective range of the second duration; or
determining a period lasting for a third duration from the effective starting moment of the second duration as the effective range of the second duration.

11. The method according to claim 8, further comprising:
reporting the effective indication information to the base station through second uplink control information (UCI) or a second media access control unit (MAC CE),
wherein the effective indication information further indicates that the terminal supports at least one of maintaining power consistency or phase continuity within the second duration.

12. (canceled)

13. (canceled)

14. The method according to claim 8, further comprising:
reporting ineffective indication information to the base station through third uplink control information (UCI) or a third media access control unit (MAC CE),
wherein the ineffective indication information is used for indicating that the second duration becomes ineffective, wherein a bit value of a first information field in the third UCI indicates an ineffectiveness value.

15. (canceled)

16. (canceled)

17. The method according to claim 14, wherein,
the ineffective indication information further indicates that the terminal is unable to support continuing to maintain power consistency or phase continuity or both within the second duration.

18. The method according to claim 1, wherein the determining that the second duration takes effect comprises one of:
determining that a joint channel estimation for an uplink channel takes effect within the second duration;
determining that a joint channel estimation for a first type of uplink channel takes effect within the second duration; or
determining that a joint channel estimation for a first transmission mode of the first type of uplink channel takes effect within the second duration.

19. A method for determining a duration, performed by a base station and comprising:
receiving a first duration reported by a terminal, wherein the first duration is a maximum span supported by the terminal for performing joint channel estimation on uplink channel;
determining a second duration for performing joint channel estimation on uplink channel, wherein the second duration is less than or equal to the first duration; and
determining that the second duration takes effect.

20. The method according to claim 19, wherein the determining a second duration for performing joint channel estimation on uplink channel comprises one of:
receiving the second duration reported by the terminal, wherein the second duration is determined by the terminal based on the first duration; or
determining, based on the first duration, at least one binding duration of a demodulation reference signal (DMRS), wherein the at least one binding duration is less than or equal to the first duration; and sending the at least one binding duration to the terminal;
when the at least one binding duration comprises one binding duration, and the second duration reported by the terminal is not received, taking the one binding duration as the second duration;
when the at least one binding duration comprises one binding duration, receiving the second duration reported by the terminal, wherein the second duration is less than or equal to the one binding duration; and
when the at least one binding duration comprises a plurality of binding durations, receiving the second duration reported by the terminal, wherein the second duration is one of the plurality of binding durations.

21. (canceled)

22. The method according to claim 20, wherein the receiving the second duration reported by the terminal comprises:
receiving the second duration reported by the terminal through first uplink control information (UCI) or a first media access control unit (MAC CE),
wherein a value indicated by a bit value of a first information field in the first UCI is equal to the second duration; or the value indicated by the bit value of the first information field in the first UCI is equal to an index value of the second duration.

23. (canceled)

24. The method according to claim 19, wherein the determining that the second duration takes effect comprises one of:
determining an effective starting moment of the second duration; or
determining an effective range of the second duration.

25. The method according to claim 24, wherein the determining an effective starting moment of the second duration comprises one of:
determining a second moment after a first moment when the terminal reports effective indication information and spaced apart from the first moment by an effective interval duration as the effective starting moment of the second duration; or
determining a third moment carried in the effective indication information reported by the terminal as the effective starting moment of the second duration, wherein the effective indication information indicates that the second duration takes effect.

26. (canceled)

27. The method according to claim 25, wherein determining an effective range of the second duration comprises one of:
determining a period from the effective starting moment of the second duration to an effective starting moment of a new second duration as the effective range of the second duration;
determining a period from the effective starting moment of the second duration till completing a first number of uplink transmissions as the effective range of the second duration;
determining a period from the effective starting moment of the second duration to an ineffective starting moment of the second duration as the effective range of the second duration; or
determining a period lasting for a third duration from the effective starting moment of the second duration as the effective range of the second duration.

28. The method according to claim 25, further comprising:
receiving the effective indication information reported by the terminal through second uplink control information (UCI) or a second media access control unit (MAC CE),
wherein the effective indication information further indicates that the terminal supports maintaining power consistency or phase continuity or both within the second duration.

29. (canceled)

30. (canceled)

31. The method according to claim 25, further comprising:
receiving ineffective indication information reported by the terminal through third uplink control information (UCI) or a third media access control unit (MAC CE),
wherein the ineffective indication information is used for indicating that the second duration becomes ineffective, wherein a bit value of a first information field in the third UCI indicates an ineffectiveness value, and the ineffective indication information further indicates that the terminal is unable to support continuing to maintain power consistency or phase continuity or both within the second duration.

32.-37. (canceled)

38. A non-transitory computer-readable storage medium storing a computer program that, when executed by a processor, causes the processor to perform the method according to claim 1.

39. A communication apparatus, comprising:
a processor; and
a memory, configured to store processor-executable instructions;
wherein the processor is configured to:
determine a first duration, wherein the first duration is a maximum span supported by a terminal for performing joint channel estimation on uplink channel;
report the first duration to a base station;
determine a second duration for performing joint channel estimation on uplink channel, wherein the second duration is less than or equal to the first duration; and
determine that the second duration takes effect.

40. (canceled)
